(19) United States
(12) Patent Application Publication
(10) Pub. No.: US 2026/0252861 A1
(43) Pub. Date: Aug. 27, 2026

(54) SYSTEM

(71) Applicant: SoftBank Group Corp., Tokyo (JP)

(72) Inventor: Ikumi TAKAHASHI, Tokyo (JP)

(73) Assignee: SoftBank Group Corp., Tokyo (JP)

(21) Appl. No.: 19/533,366

(22) Filed: Feb. 9, 2026

(30) Foreign Application Priority Data
Feb. 21, 2025 (JP) 2025-027058

(51) Int. Cl. G06N 3/0475; G06N 3/0455; H04L 67/12

(52) U.S. Cl. CPC G06N 3/0475; G06N 3/0455; H04L 67/12

(57) ABSTRACT

The system according to the embodiment comprises a collection unit, an analysis unit, a proposal unit, and a visualization unit. The collection unit collects user information. The analysis unit analyzes the information collected by the collection unit. The proposal unit proposes supplements based on an analysis result obtained by the analysis unit. The visualization unit visualizes the effects of the supplements proposed by the proposal unit.

### CROSS-REFERENCE TO RELATED APPLICATION

The present application claims priority to and incorporates by reference the entire contents of Japanese Patent Application No. 2025-027058 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, proposals and nutritional management of supplements for preconception care and pregnant women have not sufficiently addressed individual needs, leaving room for improvement.

### SUMMARY OF THE INVENTION

The system according to the embodiment comprises a collection unit, an analysis unit, a proposal unit, and a visualization unit. The collection unit collects user information. The analysis unit analyzes the information collected by the collection unit. The proposal unit proposes supplements based on an analysis result obtained by the analysis unit. The visualization unit visualizes the effects of the supplements proposed by the proposal unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

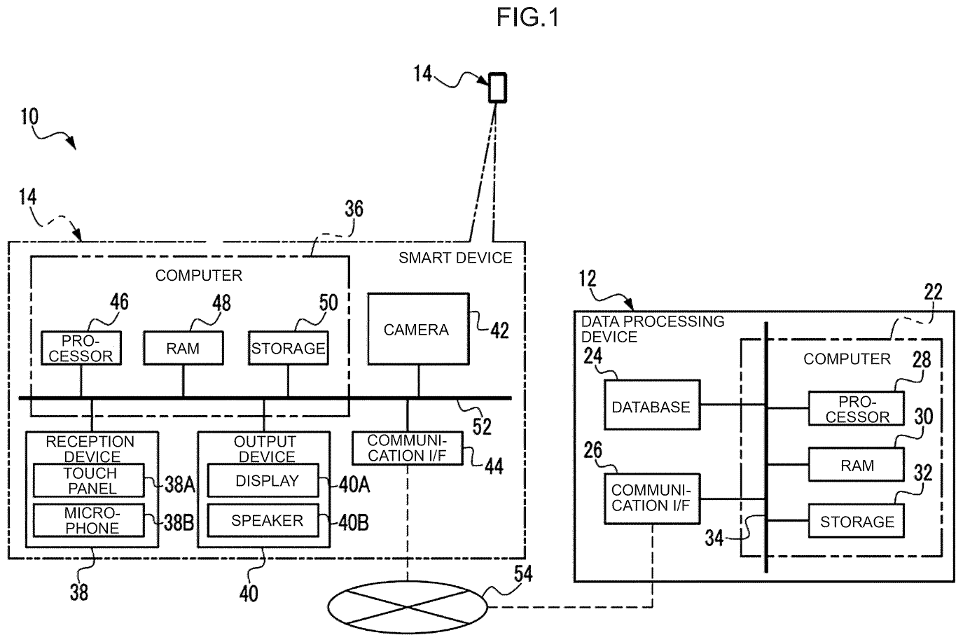

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

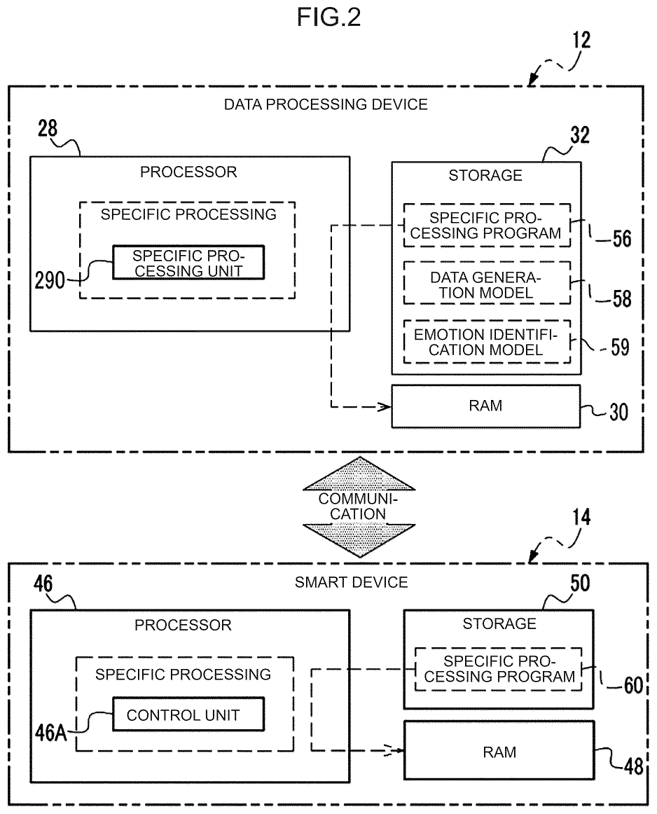

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The nutritional management system according to the embodiment of the present invention is a system for proposing nutritional supplements and managing nutrition for individuals seeking pregnancy and for pregnant and postpartum women. This nutritional management system utilizes generative AI to collect user information and feedback, and proposes supplements tailored to individual needs. Furthermore, by leveraging the advanced computational capabilities of generative AI, the system visualizes health indicators and nutritional intake status of pregnant women to support appropriate nutritional management. For example, when a user asks questions or seeks advice in natural language via an AI chatbot, the generative AI analyzes the information and proposes supplements according to the user's needs. In addition, information regarding the user's diet and lifestyle habits is also collected to enable comprehensive nutritional management. The generative AI displays the user's health indicators and nutritional intake status in graphs or charts, making it easier for the user to understand their health condition and supporting appropriate nutritional management. As a result, the nutritional management system can efficiently propose supplements and manage nutrition tailored to the individual needs of each user. Specifically, the nutritional management system acquires multidimensional data such as user health information (e.g., blood test results, weight, BMI, blood pressure, blood glucose levels as numerical vectors), dietary records (e.g., daily caloric intake and nutrient intake as time-series tensors), and lifestyle habit information (e.g., sleep duration, exercise frequency, stress level as categorical data) through the collection unit. The system performs preprocessing such as normalization, missing value imputation, and category conversion in the preprocessing unit before inputting the data to the analysis unit. The analysis unit, for example, uses Transformer-based large language models or multimodal neural networks to integratively analyze the user's natural language input (e.g., “I have been feeling tired lately,” “I am worried about iron deficiency”) and structured health data. Examples of AI model inputs include (1) structured vectors such as “30-year-old female, 8 weeks pregnant, Hb value 10.5 g/dL, average sleep 6 hours per day, skipped breakfast 3 times per week,” (2) natural language queries such as “Please tell me about your recent meals,” and (3) time-series data such as “caloric intake and iron intake over the past week.” The AI model generates outputs such as (a) supplement recommendation labels (e.g., “iron supplement recommended,” “folic acid supplement recommended”), (b) natural language explanations of the recommendation reasons (e.g., “Iron deficiency is estimated based on blood test values and dietary content”), and (c) recommendation scores (e.g., 0.85). Example outputs include “Iron supplement is recommended once daily (recommendation score 0.92)” and “Folic acid intake is below the reference value.” These outputs are used in the proposal unit for threshold judgment (e.g., only notify if recommendation score is 0.8 or higher) and branching processing according to user attributes (e.g., switching recommendations based on pregnancy week). Furthermore, the visualization unit automatically generates graphs (e.g., time-series line graphs, radar charts, heat maps) of health indicator trends and supplement intake effects from AI outputs and displays them in real time on the user interface. This allows users to intuitively grasp their health status and nutritional intake, and clearly understand the basis for individually optimized supplement proposals by AI. Unlike conventional manual interviews and data aggregation, this system autonomously performs integrated analysis of high-dimensional data, nonlinear feature extraction, and complex health status estimation that are difficult with rule-based approaches, resulting in improved proposal accuracy, significant reduction in processing speed, and enhanced personalization for each user. Application fields include not only nutritional management for individuals seeking pregnancy and for pregnant and postpartum women, but also prevention of lifestyle-related diseases, sports nutrition management, health maintenance for the elderly, and nutritional guidance for patients with chronic diseases, among various healthcare domains.

The nutritional management system according to the embodiment comprises a collection unit, an analysis unit, a proposal unit, and a visualization unit. The collection unit collects user information. User information may include, for example, health information, dietary information, and lifestyle habit information, but is not limited thereto. For example, when a user asks questions or seeks advice in natural language via an AI chatbot, the collection unit collects such information. The analysis unit uses generative AI to analyze the information collected by the collection unit. The analysis may be performed using statistical analysis or machine learning algorithms, but is not limited thereto. The generative AI analyzes the collected information to propose supplements according to the user's needs or circumstances. The proposal unit uses generative AI to propose supplements based on the analysis result obtained by the analysis unit. Proposals may include, for example, proposals based on the user's health status or personalized proposals, but are not limited thereto. The generative AI can also detect iron deficiency in the user and propose supplements containing iron. The visualization unit uses generative AI to visualize the effects of the supplements proposed by the proposal unit. Visualization may be performed using graphs or charts, but is not limited thereto. The generative AI displays the user's health indicators and nutritional intake status in graphs or charts, making it easier for the user to understand their health condition and supporting appropriate nutritional management. As a result, the nutritional management system according to the embodiment can efficiently propose supplements and manage nutrition tailored to the individual needs of each user. Specifically, the nutritional management system acquires multidimensional data such as user health information (e.g., blood test results, weight, BMI, blood pressure, blood glucose levels as numerical vectors), dietary records (e.g., daily caloric intake and nutrient intake as time-series tensors), and lifestyle habit information (e.g., sleep duration, exercise frequency, stress level as categorical data) through the collection unit. The system performs preprocessing such as normalization, missing value imputation, and category conversion in the preprocessing unit before inputting the data to the analysis unit. The analysis unit, for example, uses Transformer-based large language models or multimodal neural networks to integratively analyze the user's natural language input (e.g., “I have been feeling tired lately,” “I am worried about iron deficiency”) and structured health data. Examples of AI model inputs include (1) structured vectors such as “30-year-old female, 8 weeks pregnant, Hb value 10.5 g/dL, average sleep 6 hours per day, skipped breakfast 3 times per week,” (2) natural language queries such as “Please tell me about your recent meals,” and (3) time-series data such as “caloric intake and iron intake over the past week.” The AI model generates outputs such as (a) supplement recommendation labels (e.g., “iron supplement recommended,” “folic acid supplement recommended”), (b) natural language explanations of the recommendation reasons (e.g., “Iron deficiency is estimated based on blood test values and dietary content”), and (c) recommendation scores (e.g., 0.85). Example outputs include “Iron supplement is recommended once daily (recommendation score 0.92)” and “Folic acid intake is below the reference value.” These outputs are used in the proposal unit for threshold judgment (e.g., only notify if recommendation score is 0.8 or higher) and branching processing according to user attributes (e.g., switching recommendations based on pregnancy week). Furthermore, the visualization unit automatically generates graphs (e.g., time-series line graphs, radar charts, heat maps) of health indicator trends and supplement intake effects from AI outputs and displays them in real time on the user interface. This allows users to intuitively grasp their health status and nutritional intake, and clearly understand the basis for individually optimized supplement proposals by AI. Unlike conventional manual interviews and data aggregation, this system autonomously performs integrated analysis of high-dimensional data, nonlinear feature extraction, and complex health status estimation that are difficult with rule-based approaches, resulting in improved proposal accuracy, significant reduction in processing speed, and enhanced personalization for each user. Application fields include not only nutritional management for individuals seeking pregnancy and for pregnant and postpartum women, but also prevention of lifestyle-related diseases, sports nutrition management, health maintenance for the elderly, and nutritional guidance for patients with chronic diseases, among various healthcare domains.

The collection unit can collect information regarding a user's diet or lifestyle habits. For example, the collection unit collects information such as the user's dietary content, meal frequency, exercise habits, and sleep patterns. When a user asks questions or seeks advice in natural language via an AI chatbot, the collection unit collects such information. For example, when a user asks “Please tell me about your recent meals,” the collection unit collects that information. The collection unit also collects information regarding the user's lifestyle habits. For example, when a user asks “Please tell me about your exercise habits,” the collection unit collects that information. By collecting information regarding the user's diet and lifestyle habits, the collection unit enables more accurate supplement proposals. Specifically, the collection unit acquires dietary information such as daily caloric intake and intake amounts of major nutrients (protein, fat, carbohydrates, vitamins, minerals, etc.) as time-series tensors (e.g., a two-dimensional array of 7 days×10 nutrients). As lifestyle habit information, the collection unit collects sleep duration (e.g., hours per day), exercise frequency (e.g., number of exercise sessions per week), and stress level (e.g., questionnaire scores or biometric signals from wearable devices) as categorical data or numerical vectors. The collection unit also acquires natural language text input by the user to the chatbot, such as “I have been feeling tired lately” or “I often stay up late,” and sends these together with structured data to the analysis unit. When acquiring data, the collection unit attaches timestamps and data sources (manual input, wearable devices, external APIs, etc.) to manage data reliability and freshness. As a result, unlike simple questionnaire collection or manual recording, the collection unit can automatically collect information with high frequency and high accuracy from diverse data sources, enabling individually optimized supplement proposals and real-time understanding of health status, which are technical effects. Application fields include not only nutritional management for individuals seeking pregnancy and for pregnant and postpartum women, but also prevention of lifestyle-related diseases, nutrition management for athletes, and health maintenance for seniors, among various healthcare domains.

The analysis unit can analyze the collected information and propose supplements according to the user's needs or circumstances. For example, the analysis unit analyzes the collected information using statistical analysis or machine learning algorithms. The analysis unit uses generative AI to analyze the collected information in order to propose supplements according to the user's needs or circumstances. For example, if a user reports iron deficiency, the analysis unit analyzes the information and proposes supplements containing iron. The analysis unit also analyzes information regarding the user's diet and lifestyle habits. For example, the analysis unit analyzes the user's dietary content and exercise habits to perform comprehensive nutritional management. By analyzing the collected information, the analysis unit can propose supplements according to the user's needs or circumstances. Specifically, the analysis unit uses Transformer-based large language models or multimodal neural networks to integratively analyze user health information (e.g., blood test values, weight, BMI as numerical vectors), dietary records (e.g., time-series tensors), lifestyle habit information (e.g., categorical data), and natural language input (e.g., “I have been feeling tired lately”). Examples of AI model inputs include “30-year-old female, 8 weeks pregnant, Hb value 10.5 g/dL, average sleep 6 hours per day, skipped breakfast 3 times per week” as structured vectors, “Please tell me about your recent meals” as natural language queries, and “caloric intake and iron intake over the past week” as time-series data. The analysis unit generates outputs such as supplement recommendation labels (e.g., “iron supplement recommended,” “folic acid supplement recommended”), natural language explanations of the recommendation reasons (e.g., “Iron deficiency is estimated based on blood test values and dietary content”), and recommendation scores (e.g., 0.85). Example outputs include “Iron supplement is recommended once daily (recommendation score 0.92)” and “Folic acid intake is below the reference value.” The analysis unit sends these outputs to the proposal unit for threshold judgment and branching processing according to user attributes. Within the neural network, the analysis unit uses multi-layer Attention mechanisms and feature extraction layers to realize nonlinear analysis of high-dimensional data, which is difficult with conventional simple rule-based approaches or manual interviews. As a result, the analysis unit achieves technical effects such as improved supplement proposal accuracy, significant reduction in analysis speed, and enhanced personalization for each user. Application fields include not only nutritional management for individuals seeking pregnancy and for pregnant and postpartum women, but also prevention of lifestyle-related diseases, sports nutrition management, health maintenance for the elderly, and nutritional guidance for patients with chronic diseases, among various healthcare domains.

The visualization unit can display a user's health indicators or nutritional intake status in a graph or chart. For example, the visualization unit displays the user's health indicators and nutritional intake status in graphs or charts. The visualization unit uses generative AI to visualize the user's health indicators and nutritional intake status. For example, based on the user's blood test results and dietary records, the visualization unit displays the status of nutrient intake in graphs or charts. This makes it easier for the user to understand their health condition and enables appropriate nutritional management. The visualization unit displays health indicators such as the user's weight, BMI, and vitamin intake in graphs or charts. This allows the user to visually grasp their health condition. By visualizing the user's health indicators and nutritional intake status, the visualization unit makes it easier for the user to understand their health condition and supports appropriate nutritional management. Specifically, the visualization unit automatically generates various graph formats such as time-series line graphs, radar charts, and heat maps of health indicator trends and supplement intake effects output from the AI model. For example, the visualization unit displays the trend of iron intake over a week in a line graph or shows the balance of multiple nutrients in a radar chart. The visualization unit selects the optimal graph format for each user and displays it in real time on the user interface. Furthermore, the visualization unit can annotate the graph with AI-generated recommendation reasons and cautions (e.g., “Iron intake is below the reference value”). The visualization unit automatically detects data fluctuations and outliers, and performs alert displays or highlights using color coding. As a result, users can intuitively and in detail grasp their health status and nutritional intake, and clearly understand the basis for AI supplement proposals. Unlike conventional simple numerical displays or manual graph creation, the visualization unit realizes automatic analysis and visualization of high-dimensional data, anomaly detection, and personalized display, resulting in improved user understanding, more efficient health management, and rapid response to abnormalities. Application fields include not only nutritional management for individuals seeking pregnancy and for pregnant and postpartum women, but also prevention of lifestyle-related diseases, sports nutrition management, health maintenance for the elderly, and nutritional guidance for patients with chronic diseases, among various healthcare domains.

The proposal unit can detect iron deficiency in the user and propose supplements containing iron. The proposal unit uses generative AI to detect iron deficiency in the user and propose supplements containing iron. For example, the proposal unit detects iron deficiency based on the user's blood test results and dietary records. The proposal unit uses generative AI to detect iron deficiency in the user and propose supplements containing iron. For example, if a user reports iron deficiency, the proposal unit analyzes the information and proposes supplements containing iron. By detecting iron deficiency in the user and proposing appropriate supplements, the proposal unit supports the user's health management. Specifically, the proposal unit inputs health information received from the analysis unit (e.g., Hb value, ferritin value, iron intake in diet as numerical vectors) and natural language input (e.g., “I have been feeling anemic lately”) into the AI model, and uses Transformer-based large language models or multimodal neural networks to determine the presence or absence of iron deficiency. The AI model outputs an iron deficiency score (e.g., 0.92), recommendation label (e.g., “iron supplement recommended”), and recommendation reason (e.g., “Iron deficiency is estimated based on blood test values and dietary content”). The proposal unit notifies the user only if the recommendation score exceeds a threshold (e.g., 0.8) and explains the recommendation reason in natural language. Furthermore, the proposal unit automatically switches the type and dosage of recommended supplements according to user attribute information such as pregnancy week or medical history. If there are multiple supplement candidates, the proposal unit prioritizes proposals based on importance and relevance. Unlike conventional simple rule-based approaches or manual interviews, the system autonomously performs integrated analysis and individual optimization of high-dimensional data using AI, resulting in improved proposal accuracy, enhanced personalization for each user, and early detection of health risks. Application fields include not only nutritional management for individuals seeking pregnancy and for pregnant and postpartum women, but also prevention of lifestyle-related diseases, sports nutrition management, health maintenance for the elderly, and nutritional guidance for patients with chronic diseases, among various healthcare domains.

The visualization unit can visualize the effects of the proposed supplements and provide them to the user. The visualization unit uses generative AI to visualize the effects of the proposed supplements. For example, the visualization unit displays the user's health indicators and nutritional intake status in graphs or charts. The visualization unit uses generative AI to visualize the effects of the proposed supplements. For example, the visualization unit displays the user's health indicators and nutritional intake status in graphs or charts. This allows the user to visually grasp the effects of the proposed supplements. The visualization unit displays health indicators such as the user's weight, BMI, and vitamin intake in graphs or charts. This allows the user to visually grasp the effects of the proposed supplements. By visualizing the effects of the proposed supplements, the visualization unit makes it easier for the user to understand the effects of the supplements. Specifically, the visualization unit automatically generates time-series line graphs or radar charts of health indicator trends after supplement recommendation output from the AI model (e.g., increase in Hb value, increase in iron intake, changes in weight or BMI). The visualization unit can also display comparison graphs before and after supplement intake and color-code the effects of each recommended supplement. Furthermore, the visualization unit annotates the graph with AI-generated recommendation reasons and cautions (e.g., “Iron intake is below the reference value”), allowing the user to intuitively understand the effects and necessity of supplements. The visualization unit automatically detects abnormal values or sudden changes and performs alert or highlight displays. Unlike conventional simple numerical displays or manual graph creation, the visualization unit realizes automatic analysis and visualization of high-dimensional data, anomaly detection, and personalized display, resulting in improved user understanding, more efficient health management, and rapid response to abnormalities. Application fields include not only nutritional management for individuals seeking pregnancy and for pregnant and postpartum women, but also prevention of lifestyle-related diseases, sports nutrition management, health maintenance for the elderly, and nutritional guidance for patients with chronic diseases, among various healthcare domains.

The collection unit can estimate the user's emotions and adjust the timing of information collection based on the estimated emotions. The collection unit uses generative AI to estimate the user's emotions and adjust the timing of information collection based on the estimated emotions. For example, if the user is feeling stressed, the collection unit delays information collection until the user is in a relaxed state. The collection unit uses generative AI to estimate the user's emotions and adjust the timing of information collection based on the estimated emotions. For example, if the user is relaxed, the collection unit immediately starts information collection. The collection unit uses generative AI to estimate the user's emotions and adjust the timing of information collection based on the estimated emotions. For example, if the user is in a hurry, the collection unit collects information quickly. By adjusting the timing of information collection according to the user's emotions, the collection unit can collect information at more appropriate times. Emotion estimation is realized using, for example, an emotion engine or generative AI with emotion estimation functions. Generative AI may be a text generation AI (e.g., LLM) or multimodal generative AI, but is not limited thereto. Specifically, the collection unit acquires multimodal inputs such as the user's natural language input (e.g., text data such as “I have been irritated lately,” “I feel good today”), voice data (e.g., time-series vectors of speech rate and tone), and facial images (e.g., two-dimensional arrays of facial feature points extracted from camera images). The collection unit performs preprocessing such as normalization, noise removal, and feature extraction (e.g., emotion embedding vectorization by BERT, conversion to voice spectrograms, extraction of facial expression features) before sending the data to the analysis unit. The analysis unit uses Transformer-based large language models or multimodal neural networks (e.g., models that integratively process text, voice, and images) to output emotion labels (e.g., “stress,” “relaxation,” “tension”), emotion intensity scores (e.g., 0.85), and estimation reasons (e.g., “Stress state is estimated from speech content and tone”). Example outputs include “User emotion: stress (score 0.92)” and “User emotion: relaxation (score 0.78).” Based on these AI outputs, the collection unit executes threshold judgment (e.g., delay collection if stress score is 0.8 or higher) and branching processing (e.g., immediate collection when relaxed, collect only high-priority information when in a hurry) in the information collection timing control module. Unlike conventional subjective timing adjustment by humans or simple scheduled collection, this system autonomously analyzes high-dimensional multimodal data with AI and dynamically controls information collection timing optimized for the user's psychological state, resulting in reduced user burden, improved information collection accuracy, and optimized user experience. Application fields include not only nutritional management for individuals seeking pregnancy and for pregnant and postpartum women, but also stress management, mental healthcare, personal assistants, remote medical care, educational support, and various other domains.

The collection unit can analyze the user's past dietary history and select an appropriate information collection method. The collection unit uses generative AI to analyze the user's past dietary history and select an appropriate information collection method. For example, the collection unit analyzes patterns in the user's past meals and generates appropriate questions. The collection unit uses generative AI to analyze the user's past dietary history and select an appropriate information collection method. For example, the collection unit identifies nutrients that are lacking based on the user's dietary history and collects that information. The collection unit uses generative AI to analyze the user's past dietary history and select an appropriate information collection method. For example, the collection unit evaluates dietary balance based on the user's dietary history and collects necessary information. By analyzing the user's past dietary history, the collection unit can select the optimal information collection method. Specifically, the collection unit acquires dietary history data such as daily caloric intake and intake amounts of major nutrients (protein, fat, carbohydrates, vitamins, minerals, etc.) as time-series tensors (e.g., a two-dimensional array of 30 days×10 nutrients). The collection unit performs preprocessing such as normalization, missing value imputation, and outlier removal in the preprocessing unit before sending the data to the analysis unit. The analysis unit uses Transformer-based large language models or time-series analysis neural networks (e.g., LSTM, Temporal Convolutional Network) to extract patterns from dietary history (e.g., tendency to skip breakfast, chronic deficiency of specific nutrients, tendency for excessive intake) and evaluate dietary balance (e.g., PFC balance score, vitamin intake fulfillment rate). Examples of AI model inputs include “time-series data of iron intake over the past 30 days,” “daily meal content text,” and “structured data from dietary record apps.” The AI model generates outputs such as (a) a list of deficient nutrients (e.g., “iron,” “vitamin D”), (b) dietary pattern classification labels (e.g., “breakfast skipping type,” “high-fat type”), and (c) information collection priority scores (e.g., iron deficiency 0.92). Based on these outputs, the collection unit automatically generates individually optimized questions for the next information collection, such as “Please tell me your recent sources of iron intake” or “Please tell me the reason for skipping breakfast,” and presents them to the user. Unlike conventional uniform questionnaires or manual question design, this system uses AI for high-dimensional time-series data analysis and dynamic question generation, resulting in improved efficiency of information collection, reduced user burden, and enhanced accuracy in understanding nutritional status. Application fields include not only nutritional management for individuals seeking pregnancy and for pregnant and postpartum women, but also prevention of lifestyle-related diseases, sports nutrition guidance, health maintenance for seniors, and personal diet support, among various healthcare domains.

The collection unit can perform filtering based on the user's current health status or lifestyle habits at the time of information collection. The collection unit uses generative AI to perform filtering based on the user's current health status or lifestyle habits at the time of information collection. For example, the collection unit evaluates the user's current health status and collects only necessary information. The collection unit uses generative AI to perform filtering based on the user's current health status or lifestyle habits at the time of information collection. For example, the collection unit prioritizes the collection of highly relevant information based on the user's lifestyle habits. The collection unit uses generative AI to perform filtering based on the user's current health status or lifestyle habits at the time of information collection. For example, the collection unit adjusts the scope of information collection according to the user's health status or lifestyle habits. By filtering information based on the user's current health status or lifestyle habits, the collection unit can collect highly relevant information. Specifically, the collection unit acquires multidimensional data such as user health information (e.g., blood test values, weight, BMI, blood pressure, blood glucose levels as numerical vectors) and lifestyle habit information (e.g., sleep duration, exercise frequency, stress level as categorical data). The collection unit performs preprocessing such as normalization, category conversion, and missing value imputation in the preprocessing unit before sending the data to the analysis unit. The analysis unit uses Transformer-based large language models or multimodal neural networks to output health status scores (e.g., Hb value 0.92, BMI 23.5), lifestyle habit cluster labels (e.g., “night type,” “lack of exercise”), and health risk estimation (e.g., iron deficiency risk 0.85). Based on these AI outputs, the collection unit uses the information collection filtering module to preferentially select items highly relevant to health status or lifestyle habits (e.g., if iron deficiency risk is high, collect only information regarding sources of iron intake) and suppress unnecessary information collection. Unlike conventional uniform information collection or manual item selection, this system uses AI for high-dimensional data analysis and dynamic filtering, resulting in improved efficiency of information collection, reduced user burden, and enhanced accuracy in acquiring highly relevant data. Application fields include not only nutritional management for individuals seeking pregnancy and for pregnant and postpartum women, but also prevention of lifestyle-related diseases, sports nutrition guidance, chronic disease management, personal health monitoring, and various other healthcare domains.

The collection unit can estimate the user's emotions and determine the priority of information to be collected based on the estimated emotions. The collection unit uses generative AI to estimate the user's emotions and determine the priority of information to be collected based on the estimated emotions. For example, if the user is feeling stressed, the collection unit prioritizes the collection of information related to stress reduction. The collection unit uses generative AI to estimate the user's emotions and determine the priority of information to be collected based on the estimated emotions. For example, if the user is relaxed, the collection unit prioritizes the collection of information related to health maintenance. The collection unit uses generative AI to estimate the user's emotions and determine the priority of information to be collected based on the estimated emotions. For example, if the user is in a hurry, the collection unit prioritizes the collection of important information. By determining the priority of information to be collected according to the user's emotions, the collection unit can prioritize the collection of more important information. Emotion estimation is realized using, for example, an emotion engine or generative AI with emotion estimation functions. Generative AI may be a text generation AI (e.g., LLM) or multimodal generative AI, but is not limited thereto. Specifically, the collection unit acquires multimodal inputs such as the user's natural language input (e.g., “I have been feeling down lately,” “I feel energetic today”), voice data (e.g., time-series vectors of tone and speech rate), and facial images (e.g., two-dimensional arrays of facial feature points). The collection unit performs preprocessing such as normalization and feature extraction (e.g., emotion embedding by BERT, conversion to voice spectrograms, extraction of facial expression features) before sending the data to the analysis unit. The analysis unit uses Transformer-based large language models or multimodal neural networks to output emotion labels (e.g., “stress,” “relaxation,” “tension”), emotion intensity scores (e.g., 0.88), and estimation reasons (e.g., “Stress state is estimated from speech content and facial expression”). Based on these AI outputs, the collection unit uses the information collection priority determination module to control the collection of information, such as prioritizing information related to stress reduction (e.g., relaxation methods, sleep improvement measures) during stress, health maintenance information (e.g., nutritional balance, exercise habits) during relaxation, and highly important information (e.g., recent health risk factors) when in a hurry. Unlike conventional uniform information collection or manual prioritization, this system uses AI for multimodal emotion estimation and dynamic priority control, resulting in improved efficiency of information collection, reduced user burden, and rapid acquisition of important information. Application fields include not only nutritional management for individuals seeking pregnancy and for pregnant and postpartum women, but also stress management, mental healthcare, personal assistants, remote medical care, and various other domains.

The collection unit can preferentially collect highly relevant information based on the user's geographic location information at the time of information collection. The collection unit uses generative AI to preferentially collect highly relevant information based on the user's geographic location information at the time of information collection. For example, the collection unit collects region-specific nutritional information based on the user's current location. The collection unit uses generative AI to preferentially collect highly relevant information based on the user's geographic location information at the time of information collection. For example, the collection unit collects information about nearby supplement retailers based on the user's geographic location information. The collection unit uses generative AI to preferentially collect highly relevant information based on the user's geographic location information at the time of information collection. For example, the collection unit collects information about local ingredients by considering the user's geographic location information. By considering the user's geographic location information, the collection unit can collect region-specific highly relevant information. Specifically, the collection unit acquires GPS coordinates and location information (e.g., latitude/longitude, prefecture, city/town as categorical data) obtained from user terminals or wearable devices. The collection unit performs preprocessing such as geocoding and area classification (e.g., urban, rural, coastal) in the preprocessing unit before sending the data to the analysis unit. The analysis unit combines location information with health and nutrition databases (e.g., regional ingredient distribution information, supplement retailer lists, region-specific nutrition risks) to output relevance scores (e.g., region-specific nutrient deficiency risk 0.85) and recommended information lists (e.g., “Iron deficiency is common in this region,” “Supplements available at nearby retailers”). Based on these AI outputs, the collection unit uses the information collection priority control module to preferentially collect region-specific nutritional information, nearby retailer information, and local ingredient information. Unlike conventional uniform information collection or manual selection of regional information, this system uses AI for location information integration and dynamic priority control, resulting in optimized information collection for regional characteristics, improved user experience, and early identification of regional nutrition risks. Application fields include not only nutritional management for individuals seeking pregnancy and for pregnant and postpartum women, but also regional medical collaboration, nutritional support during disasters, health services for tourists, regional revitalization support, and various other domains.

The collection unit can analyze the user's social media activity at the time of information collection and collect relevant information. The collection unit uses generative AI to analyze the user's social media activity at the time of information collection and collect relevant information. For example, the collection unit analyzes the user's social media posts and collects information based on interests. The collection unit uses generative AI to analyze the user's social media activity at the time of information collection and collect relevant information. For example, the collection unit collects relevant nutritional information based on the user's follow relationships on social media. The collection unit uses generative AI to analyze the user's social media activity at the time of information collection and collect relevant information. For example, the collection unit analyzes the user's activity history on social media and collects appropriate supplement information. By analyzing the user's social media activity, the collection unit can collect information based on interests. Specifically, the collection unit automatically acquires user social media post data (e.g., text posts, image posts, video links as time-series data), follow/follower relationships (e.g., graph structure data of user IDs), and reaction history to posts (e.g., likes, comments, shares as categorical data) via APIs. The collection unit performs preprocessing such as normalization and tokenization of natural language text, feature extraction for sentiment analysis (e.g., embedding vectorization by BERT or RoBERTa), image feature extraction for image posts (e.g., label estimation by CNN), and calculation of network centrality or clustering indices for graph data. The collection unit integrates these diverse features and sends them to the analysis unit. The analysis unit uses Transformer-based large language models or multimodal neural networks to estimate health and nutrition-related interest topics from user posts (e.g., “iron,” “vitamin D,” “diet”), emotional tendencies (e.g., “health anxiety,” “motivation improvement”), and influence scores on the social graph (e.g., health information diffusion score 0.85). Examples of AI model inputs include (1) time-series data of health-related posts over the past 30 days, (2) lists of health influencers followed, and (3) automatic labels of meal photos in image posts. The AI model generates outputs such as (a) user interest labels (e.g., “iron supplementation,” “low-carb diet”), (b) relevance scores (e.g., iron-related post frequency 0.92), and (c) recommended information lists (e.g., “recently popular iron supplements,” “nutrients recommended by followed experts”). Based on these AI outputs, the collection unit uses the information collection priority control module to preferentially collect health and nutrition information or supplement information matching the user's interests and suppress unnecessary information collection. Unlike conventional uniform questionnaires or manual estimation of interests, this system uses AI for high-dimensional multimodal data analysis and dynamic information collection control, resulting in improved personalization for each user, significant improvement in information collection efficiency, and enhanced accuracy in acquiring highly relevant data. Application fields include not only nutritional management for individuals seeking pregnancy and for pregnant and postpartum women, but also prevention of lifestyle-related diseases, sports nutrition guidance, personal healthcare, SNS-linked health services, and various other healthcare domains.

The analysis unit can estimate the user's emotions and adjust the expression method of analysis based on the estimated emotions. The analysis unit uses generative AI to estimate the user's emotions and adjust the expression method of analysis based on the estimated emotions. For example, if the user is feeling stressed, the analysis unit provides simple and easy-to-understand analysis results. The analysis unit uses generative AI to estimate the user's emotions and adjust the expression method of analysis based on the estimated emotions. For example, if the user is relaxed, the analysis unit provides detailed analysis results. The analysis unit uses generative AI to estimate the user's emotions and adjust the expression method of analysis based on the estimated emotions. For example, if the user is in a hurry, the analysis unit provides concise analysis results. By adjusting the expression method of analysis according to the user's emotions, the analysis unit can provide more appropriate analysis results. Emotion estimation is realized using, for example, an emotion engine or generative AI with emotion estimation functions. Generative AI may be a text generation AI (e.g., LLM) or multimodal generative AI, but is not limited thereto. Specifically, the analysis unit receives multimodal inputs such as the user's natural language input (e.g., “I have been feeling down lately,” “I feel energetic today”), voice data (e.g., time-series vectors of tone and speech rate), and facial images (e.g., two-dimensional arrays of facial feature points). The analysis unit performs preprocessing such as normalization and feature extraction (e.g., emotion embedding by BERT, conversion to voice spectrograms, extraction of facial expression features) before inputting the data to a multimodal neural network. The AI model outputs emotion labels (e.g., “stress,” “relaxation,” “tension”), emotion intensity scores (e.g., 0.88), and estimation reasons (e.g., “Stress state is estimated from speech content and facial expression”). Based on these outputs, the analysis result generation module dynamically switches the expression method of analysis results according to the user's emotional state. For example, in a stress state, the output may be a concise expression such as “Iron intake is below the reference value. Let's start with simple dietary improvements.” In a relaxed state, the output may be a detailed explanation such as “Average iron intake over the past week is 8.5 mg, which is 85% of the recommended value of 10 mg. Detailed analysis of dietary content is as follows.” In a hurry, the output may be a summary such as “Tendency toward iron deficiency. Supplement recommended.” Examples of AI model inputs include (1) natural language queries such as “Please tell me about your recent meals,” (2) time-series data of caloric intake and iron intake over the past week, and (3) emotional state from voice input. The AI model automatically selects the expression format of analysis results (e.g., detailed explanation, summary, bullet points) from these inputs to optimize the user experience. Unlike conventional uniform presentation of analysis results or manual adjustment of expression, this system uses AI for multimodal emotion estimation and dynamic expression control, resulting in improved user understanding, stress reduction, and optimization of information transmission efficiency for each user. Application fields include not only nutritional management for individuals seeking pregnancy and for pregnant and postpartum women, but also stress management, mental healthcare, personal assistants, remote medical care, and various other domains.

The analysis unit can adjust the level of detail of analysis based on the importance of the collected information during analysis. The analysis unit uses generative AI to adjust the level of detail of analysis based on the importance of the collected information during analysis. For example, the analysis unit performs detailed analysis for highly important information. The analysis unit uses generative AI to adjust the level of detail of analysis based on the importance of the collected information during analysis. For example, the analysis unit performs simplified analysis for less important information. The analysis unit uses generative AI to adjust the level of detail of analysis based on the importance of the collected information during analysis. For example, the analysis unit determines the priority of analysis according to the importance of the collected information. By adjusting the level of detail of analysis based on the importance of the collected information, the analysis unit can perform detailed analysis for important information. Specifically, the analysis unit integrates health information (e.g., blood test values, weight, BMI as numerical vectors), dietary records (e.g., time-series tensors), lifestyle habit information (e.g., categorical data), and natural language input (e.g., “I have been feeling tired lately”) received from the collection unit, performs normalization and feature extraction in the preprocessing unit, and inputs the data to the importance estimation module. The AI model calculates importance scores for each information item (e.g., Hb value 0.95, sleep duration 0.65, dietary content 0.88), applies multi-layer Attention mechanisms and detailed feature extraction layers for highly important information, and applies shallow layers or summary processing only for less important information. Examples of AI model inputs include (1) time-series data of blood test values and dietary records over the past week, (2) categorical data of sleep duration and exercise frequency, and (3) natural language health consultation content. The AI model generates outputs such as (a) detailed analysis results (e.g., factor analysis of iron deficiency, time-series graphs of intake trends), (b) simplified analysis results (e.g., sleep duration is within the reference value), and (c) analysis priority lists (e.g., iron>vitamin D>exercise frequency). Based on these outputs, the analysis unit presents important information in detail and less important information as key points to the user. Unlike conventional uniform analysis or manual importance judgment, this system uses AI for automatic importance estimation of high-dimensional data and dynamic analysis control, resulting in improved analysis efficiency, reduced user burden, and prevention of overlooking important information. Application fields include not only nutritional management for individuals seeking pregnancy and for pregnant and postpartum women, but also prevention of lifestyle-related diseases, sports nutrition guidance, chronic disease management, personal health monitoring, and various other healthcare domains.

The analysis unit can apply different analysis algorithms according to the category of information during analysis. The analysis unit uses generative AI to apply different analysis algorithms according to the category of information during analysis. For example, the analysis unit applies a nutrition analysis algorithm to nutritional information. The analysis unit uses generative AI to apply different analysis algorithms according to the category of information during analysis. For example, the analysis unit applies a health analysis algorithm to health indicators. The analysis unit uses generative AI to apply different analysis algorithms according to the category of information during analysis. For example, the analysis unit applies a lifestyle habit analysis algorithm to lifestyle habit information. By applying different analysis algorithms according to the category of information, the analysis unit can provide more accurate analysis results. Specifically, the analysis unit receives multidimensional data such as numerical vectors of health indicators, time-series tensors of dietary records, categorical data of lifestyle habits, and natural language input from the collection unit, performs normalization, category conversion, and feature extraction in the preprocessing unit, and inputs the data to the information category determination module. The AI model automatically determines the category of input data (e.g., nutritional information, health indicators, lifestyle habits, emotional data) and applies the optimal analysis algorithm for each category (e.g., nutrient balance evaluation algorithm for nutritional information, anomaly detection algorithm for health indicators, clustering or pattern mining algorithms for lifestyle habits). Examples of AI model inputs include (1) time-series data of daily nutrient intake, (2) numerical vectors of blood test values, and (3) categorical data of exercise frequency and sleep duration. The AI model generates outputs such as (a) category-specific analysis results (e.g., nutrient balance score, health risk estimation, lifestyle habit cluster labels), (b) overall evaluation scores (e.g., health score 0.85), and (c) recommended action lists (e.g., increase iron intake, improve exercise habits). Based on these outputs, the analysis unit presents analysis results optimized for each category to the user. Unlike conventional uniform algorithm application or manual category determination, this system uses AI for automatic category determination and dynamic algorithm selection, resulting in improved analysis accuracy, enhanced processing efficiency, and multifaceted evaluation of complex health conditions. Application fields include not only nutritional management for individuals seeking pregnancy and for pregnant and postpartum women, but also prevention of lifestyle-related diseases, sports nutrition guidance, chronic disease management, personal health monitoring, and various other healthcare domains.

The analysis unit can estimate the user's emotions and adjust the length of analysis based on the estimated emotions. The analysis unit uses generative AI to estimate the user's emotions and adjust the length of analysis based on the estimated emotions. For example, if the user is feeling stressed, the analysis unit provides concise analysis results that focus on key points. The analysis unit uses generative AI to estimate the user's emotions and adjust the length of analysis based on the estimated emotions. For example, if the user is relaxed, the analysis unit provides detailed analysis results. The analysis unit uses generative AI to estimate the user's emotions and adjust the length of analysis based on the estimated emotions. For example, if the user is in a hurry, the analysis unit provides analysis results quickly. By adjusting the length of analysis according to the user's emotions, the analysis unit can provide more appropriate analysis results. Emotion estimation is realized using, for example, an emotion engine or generative AI with emotion estimation functions. Generative AI may be a text generation AI (e.g., LLM) or multimodal generative AI, but is not limited thereto. Specifically, the analysis unit receives multimodal inputs such as the user's natural language input (e.g., “I have been irritated lately,” “I feel good today”), voice data (e.g., time-series vectors of speech rate and tone), and facial images (e.g., two-dimensional arrays of facial feature points). The analysis unit performs preprocessing such as normalization and feature extraction (e.g., emotion embedding by BERT, conversion to voice spectrograms, extraction of facial expression features) before inputting the data to a multimodal neural network. The AI model outputs emotion labels (e.g., “stress,” “relaxation,” “tension”), emotion intensity scores (e.g., 0.85), and estimation reasons (e.g., “Stress state is estimated from speech content and tone”). Based on these outputs, the analysis result generation module dynamically switches the length of analysis results (e.g., detailed explanation, summary, bullet points) according to the user's emotional state. Examples of AI model inputs include (1) time-series data of dietary records and health indicators over the past week, (2) natural language health consultation content, and (3) emotional state from voice input. The AI model automatically adjusts the length of analysis results from these inputs to optimize the user experience. Unlike conventional uniform presentation of analysis results or manual adjustment of length, this system uses AI for multimodal emotion estimation and dynamic length control, resulting in improved user understanding, stress reduction, and optimization of information transmission efficiency for each user. Application fields include not only nutritional management for individuals seeking pregnancy and for pregnant and postpartum women, but also stress management, mental healthcare, personal assistants, remote medical care, and various other domains.

The analysis unit can determine the priority of analysis based on the timing of information collection during analysis. The analysis unit uses generative AI to determine the priority of analysis based on the timing of information collection during analysis. For example, the analysis unit prioritizes the analysis of the latest information. The analysis unit uses generative AI to determine the priority of analysis based on the timing of information collection during analysis. For example, the analysis unit analyzes older information later. The analysis unit uses generative AI to determine the priority of analysis based on the timing of information collection during analysis. For example, the analysis unit adjusts the order of analysis according to the timing of information collection. By determining the priority of analysis based on the timing of information collection, the analysis unit can prioritize the analysis of the latest information. Specifically, the analysis unit attaches timestamps and collection date metadata to each data item such as health information, dietary records, and lifestyle habit information received from the collection unit, and performs time-series alignment, new/old determination, and calculation of data freshness scores in the preprocessing unit. The AI model automatically calculates priority scores for each data item based on the timing of information collection (e.g., latest data 0.95, data from one week ago 0.65), and applies multi-layer Attention mechanisms and detailed analysis layers to higher-priority data first. Examples of AI model inputs include (1) time-series data of blood test values and dietary records over the past 7 days, (2) categorical data of recent sleep duration and exercise frequency, and (3) health consultation content from one month ago. The AI model generates outputs such as (a) analysis priority lists (e.g., latest data>data from one week ago>data from one month ago), (b) priority-based analysis results (e.g., detailed analysis for latest data, summary analysis for older data), and (c) outputs with data freshness scores. Based on these outputs, the analysis unit presents analysis results that emphasize the latest information to the user. Unlike conventional uniform analysis order or manual time-series management, this system uses AI for automatic time-series priority determination and dynamic analysis order control, resulting in improved analysis efficiency, ensured information freshness, and rapid understanding of changes in health status. Application fields include not only nutritional management for individuals seeking pregnancy and for pregnant and postpartum women, but also prevention of lifestyle-related diseases, sports nutrition guidance, chronic disease management, personal health monitoring, and various other healthcare domains.

The analysis unit can adjust the order of analysis based on the relevance of the information during analysis. The analysis unit uses generative AI to adjust the order of analysis based on the relevance of the information during analysis. For example, the analysis unit prioritizes the analysis of highly relevant information. The analysis unit uses generative AI to adjust the order of analysis based on the relevance of the information during analysis. For example, the analysis unit analyzes less relevant information later. The analysis unit uses generative AI to adjust the order of analysis based on the relevance of the information during analysis. For example, the analysis unit adjusts the order of analysis according to the relevance of the information. By adjusting the order of analysis based on the relevance of the information, the analysis unit can prioritize the analysis of highly relevant information. Specifically, the analysis unit performs feature extraction, category conversion, and calculation of relevance scores (e.g., correlation coefficients, co-occurrence frequency, AI-based relevance estimation) in the preprocessing unit for each data item such as health information, dietary records, lifestyle habit information, and natural language input received from the collection unit. The AI model quantifies the relevance between information items using graph neural networks or Attention mechanisms, and performs detailed analysis in order of higher relevance. Examples of AI model inputs include (1) simultaneous time-series data of blood test values and dietary records, (2) correlation data of sleep duration and stress level, and (3) health consultation content and lifestyle habit information. The AI model generates outputs such as (a) analysis order lists (e.g., blood test values and dietary records with relevance 0.92 are prioritized for analysis), (b) analysis results with relevance scores, and (c) summary analysis of low-relevance data. Based on these outputs, the analysis unit presents analysis results that emphasize highly relevant information to the user. Unlike conventional uniform analysis order or manual relevance judgment, this system uses AI for automatic relevance estimation and dynamic analysis order control, resulting in improved analysis efficiency, prevention of overlooking important information, and multifaceted evaluation of complex health conditions. Application fields include not only nutritional management for individuals seeking pregnancy and for pregnant and postpartum women, but also prevention of lifestyle-related diseases, sports nutrition guidance, chronic disease management, personal health monitoring, and various other healthcare domains.

The proposal unit is capable of estimating the user's emotions and adjusting the method of presenting proposals based on the estimated emotions. The proposal unit uses generative AI to estimate the user's emotions and adjusts the method of presenting proposals according to the estimated emotions. For example, when the user is feeling stressed, the proposal unit provides simple and easy-to-understand proposals. The proposal unit uses generative AI to estimate the user's emotions and adjusts the method of presenting proposals based on the estimated emotions. For instance, when the user is relaxed, the proposal unit provides detailed proposals. The proposal unit uses generative AI to estimate the user's emotions and adjusts the method of presenting proposals based on the estimated emotions. For example, when the user is in a hurry, the proposal unit provides concise proposals focusing on key points. By adjusting the method of presenting proposals according to the user's emotions, the proposal unit can provide more appropriate proposals. Emotion estimation is realized, for example, by using an emotion engine or emotion estimation function implemented with generative AI. Generative AI may include text generation AI (such as LLMs) or multimodal generative AI, but is not limited to these examples. Specifically, the proposal unit receives multimodal inputs from the collection unit, such as the user's natural language input (e.g., text data like “I've been feeling down lately” or “I'm feeling good today”), voice data (e.g., time-series vectors of voice tone and speaking rate), and facial expression images (e.g., two-dimensional arrays of facial feature points). The proposal unit performs normalization and feature extraction on these data in the preprocessing unit (e.g., emotion embedding vectorization using BERT, conversion to voice spectrograms, extraction of facial expression features), and the analysis unit outputs emotion labels (e.g., “stress,” “relaxation,” “tension”), emotion intensity scores (e.g., 0.88), and reasons for estimation (e.g., “Stress state is estimated from speech content and facial expression”). Examples of inputs to the AI model include: (1) natural language queries such as “Please tell me your recent dietary habits”; (2) time-series data of calorie intake and iron intake over the past week; (3) emotional state from voice input. The AI model automatically selects the format for presenting analysis results (e.g., detailed explanation, summary, bullet points) based on these inputs, and the proposal unit dynamically switches the method of presenting proposal content according to the user's emotional state. For example, in a stress state, a concise expression such as “Your iron intake is below the standard value. Let's start with simple dietary improvements.” is generated; in a relaxed state, a detailed explanation such as “Your average iron intake over the past week is 8.5 mg, which is 85% of the recommended value of 10 mg. The detailed analysis of your diet is as follows.” is generated; and in a hurry, a summary such as “Tendency toward iron deficiency. Supplement recommended.” is generated. These outputs are further personalized by a user experience optimization module and immediately reflected in the user interface. Unlike conventional uniform proposal presentations or manual adjustment of expressions, the present system achieves technical effects such as improved user comprehension, stress reduction, and optimization of information transmission efficiency through AI-based multimodal emotion estimation and dynamic control of presentation methods. Application fields include not only nutrition management for conception and pregnant women, but also stress management, mental health care, personal assistants, telemedicine, and various other fields.

The proposal unit is capable of adjusting the level of detail of proposals at the time of proposal based on the importance of the supplements. The proposal unit uses generative AI to adjust the level of detail of proposals at the time of proposal according to the importance of the supplements. For example, the proposal unit provides detailed proposals for highly important supplements. The proposal unit uses generative AI to adjust the level of detail of proposals at the time of proposal according to the importance of the supplements. For instance, for supplements of low importance, the proposal unit provides simplified proposals. The proposal unit uses generative AI to adjust the level of detail of proposals at the time of proposal according to the importance of the supplements. For example, the proposal unit determines the priority of proposals according to the importance of the supplements. By adjusting the level of detail of proposals based on the importance of the supplements, the proposal unit can provide detailed proposals for important supplements. Specifically, the proposal unit integrates health information received from the analysis unit (e.g., numerical vectors such as blood test values, weight, BMI), dietary records (e.g., time-series tensors), lifestyle information (e.g., categorical data), and natural language input (e.g., “I've been feeling tired lately”), performs normalization and feature extraction in the preprocessing unit, and inputs the data into a supplement importance estimation module. The AI model calculates an importance score for each supplement candidate (e.g., iron supplement 0.95, vitamin D supplement 0.65, magnesium supplement 0.88), applies multi-layer attention mechanisms and detailed feature extraction layers for highly important supplements to deepen the proposal content, and applies summarization or simple explanations only for less important supplements. Examples of inputs to the AI model include: (1) time-series data of blood test values and dietary records over the past week; (2) categorical data of sleep duration and exercise frequency; (3) health consultation content in natural language. The AI model outputs (a) detailed proposal content (e.g., analysis of causes of iron deficiency, recommendations with time-series graphs of intake trends), (b) simplified proposal content (e.g., vitamin D is within the standard value), and (c) a proposal priority list (e.g., iron >vitamin D>magnesium) based on these inputs. The proposal unit presents detailed information for important supplements and only the key points for less important supplements to the user. Unlike conventional uniform proposals or manual determination of importance, the present system achieves technical effects such as improved proposal efficiency, reduced user burden, and prevention of overlooking important supplements through AI-based automatic high-dimensional data importance estimation and dynamic proposal control. Application fields include not only nutrition management for conception and pregnant women, but also prevention of lifestyle-related diseases, sports nutrition guidance, chronic disease management, personal health monitoring, and various healthcare domains.

The proposal unit is capable of applying different proposal algorithms at the time of proposal according to the category of the supplements. The proposal unit uses generative AI to apply different proposal algorithms at the time of proposal according to the category of the supplements. For example, for iron supplements, the proposal unit applies a proposal algorithm related to iron supplementation. The proposal unit uses generative AI to apply different proposal algorithms at the time of proposal according to the category of the supplements. For instance, for vitamin supplements, the proposal unit applies a proposal algorithm related to vitamin supplementation. The proposal unit uses generative AI to apply different proposal algorithms at the time of proposal according to the category of the supplements. For example, for mineral supplements, the proposal unit applies a proposal algorithm related to mineral supplementation. By applying different proposal algorithms according to the category of the supplements, the proposal unit can provide more appropriate proposals. Specifically, the proposal unit normalizes, categorizes, and extracts features from multidimensional data received from the analysis unit (e.g., numerical vectors of health indicators, time-series tensors of dietary records, categorical data of lifestyle habits, natural language input) in the preprocessing unit, and inputs the data into a supplement category determination module. The AI model automatically determines the category of the input data (e.g., iron supplement, vitamin supplement, mineral supplement) and applies the optimal proposal algorithm for each category (e.g., iron deficiency risk estimation algorithm for iron supplements, vitamin sufficiency evaluation algorithm for vitamin supplements, mineral balance optimization algorithm for mineral supplements). Examples of inputs to the AI model include: (1) time-series data of daily nutrient intake; (2) numerical vectors of blood test values; (3) categorical data of exercise frequency and sleep duration. The AI model outputs (a) category-specific proposal content (e.g., reasons for recommending iron supplements, recommended amount of vitamin supplements, timing for mineral supplement intake), (b) comprehensive proposal scores (e.g., iron 0.92, vitamin 0.85), and (c) recommended action lists (e.g., increase iron intake, combine with vitamin C) based on these inputs. The proposal unit presents optimized proposal content for each category to the user. Unlike conventional uniform algorithm application or manual category determination, the present system achieves technical effects such as improved proposal accuracy, enhanced processing efficiency, and multifaceted evaluation of complex health conditions through AI-based automatic category determination and dynamic algorithm selection. Application fields include not only nutrition management for conception and pregnant women, but also prevention of lifestyle-related diseases, sports nutrition guidance, chronic disease management, personal health monitoring, and various healthcare domains.

The proposal unit is capable of estimating the user's emotions and adjusting the length of proposals based on the estimated emotions. The proposal unit uses generative AI to estimate the user's emotions and adjusts the length of proposals according to the estimated emotions. For example, when the user is feeling stressed, the proposal unit provides short and concise proposals focusing on key points. The proposal unit uses generative AI to estimate the user's emotions and adjusts the length of proposals based on the estimated emotions. For instance, when the user is relaxed, the proposal unit provides detailed proposals. The proposal unit uses generative AI to estimate the user's emotions and adjusts the length of proposals based on the estimated emotions. For example, when the user is in a hurry, the proposal unit provides quick proposals. By adjusting the length of proposals according to the user's emotions, the proposal unit can provide more appropriate proposals. Emotion estimation is realized, for example, by using an emotion engine or emotion estimation function implemented with generative AI. Generative AI may include text generation AI (such as LLMs) or multimodal generative AI, but is not limited to these examples. Specifically, the proposal unit receives multimodal inputs from the collection unit, such as the user's natural language input (e.g., “I've been irritated lately,” “I'm feeling good today”), voice data (e.g., time-series vectors of speaking rate and voice tone), and facial expression images (e.g., two-dimensional arrays of facial feature points). The proposal unit performs normalization and feature extraction on these data in the preprocessing unit (e.g., emotion embedding using BERT, conversion to voice spectrograms, extraction of facial expression features), and the analysis unit outputs emotion labels (e.g., “stress,” “relaxation,” “tension”), emotion intensity scores (e.g., 0.85), and reasons for estimation (e.g., “Stress state is estimated from speech content and voice tone”). Examples of inputs to the AI model include: (1) time-series data of dietary records and health indicators over the past week; (2) health consultation content in natural language; (3) emotional state from voice input. The AI model automatically adjusts the length of proposal content (e.g., detailed explanation, summary, bullet points) based on these inputs to optimize the user experience. For example, in a stress state, a short proposal focusing only on key points such as “Tendency toward iron deficiency. Supplement recommended.” is generated; in a relaxed state, a detailed proposal such as “Your average iron intake over the past week is 8.5 mg, which is 85% of the recommended value of 10 mg. The detailed analysis of your diet is as follows.” is generated; and in a hurry, a quick proposal such as “Iron supplement recommended once daily.” is generated. Unlike conventional uniform proposal presentations or manual adjustment of length, the present system achieves technical effects such as improved user comprehension, stress reduction, and optimization of information transmission efficiency through AI-based multimodal emotion estimation and dynamic control of proposal length. Application fields include not only nutrition management for conception and pregnant women, but also stress management, mental health care, personal assistants, telemedicine, and various other fields.

The proposal unit is capable of determining the priority of proposals at the time of proposal based on the submission timing of the supplements. The proposal unit uses generative AI to determine the priority of proposals at the time of proposal according to the submission timing of the supplements. For example, the proposal unit prioritizes the latest supplements for proposal. The proposal unit uses generative AI to determine the priority of proposals at the time of proposal according to the submission timing of the supplements. For instance, older supplements are proposed later. The proposal unit uses generative AI to determine the priority of proposals at the time of proposal according to the submission timing of the supplements. For example, the proposal unit adjusts the order of proposals according to the submission timing of the supplements. By determining the priority of proposals based on the submission timing of the supplements, the proposal unit can prioritize the latest supplements for proposal. Specifically, the proposal unit assigns submission timing metadata (e.g., recommendation generation date, latest update date) to each supplement candidate received from the analysis unit, and performs time-series alignment, new/old determination, and calculation of data freshness scores in the preprocessing unit. The AI model automatically calculates a priority score for each supplement candidate based on submission timing (e.g., latest supplement 0.95, supplement from one week ago 0.65), and executes detailed proposals in order of higher priority. Examples of inputs to the AI model include: (1) recommendation history of supplements over the past seven days; (2) time-series data of recent health indicators and supplement proposals; (3) proposal content of supplements from one month ago. The AI model outputs (a) proposal priority list (e.g., latest supplement>supplement from one week ago>supplement from one month ago), (b) proposal content by priority (e.g., detailed proposals for latest supplements, summary proposals for older supplements), and (c) output with data freshness scores. The proposal unit presents proposal content to the user that emphasizes the latest information based on these outputs. Unlike conventional uniform proposal order or manual time-series management, the present system achieves technical effects such as improved proposal efficiency, ensured information freshness, and rapid response to changes in health status through AI-based automatic time-series priority determination and dynamic proposal order control. Application fields include not only nutrition management for conception and pregnant women, but also prevention of lifestyle-related diseases, sports nutrition guidance, chronic disease management, personal health monitoring, and various healthcare domains.

The proposal unit is capable of adjusting the order of proposals at the time of proposal based on the relevance of the supplements. The proposal unit uses generative AI to adjust the order of proposals at the time of proposal according to the relevance of the supplements. For example, the proposal unit prioritizes highly relevant supplements for proposal. The proposal unit uses generative AI to adjust the order of proposals at the time of proposal according to the relevance of the supplements. For instance, less relevant supplements are proposed later. The proposal unit uses generative AI to adjust the order of proposals at the time of proposal according to the relevance of the supplements. For example, the proposal unit adjusts the order of proposals according to the relevance of the supplements. By adjusting the order of proposals based on the relevance of the supplements, the proposal unit can prioritize highly relevant supplements for proposal. Specifically, the proposal unit performs feature extraction, category conversion, and calculation of relevance scores (e.g., correlation coefficients, co-occurrence frequency, AI-based relevance estimation) in the preprocessing unit for each data received from the analysis unit, such as health information, dietary records, lifestyle information, and natural language input. The AI model quantifies the relevance between each supplement candidate and the user's health status, lifestyle habits, and dietary content using graph neural networks or attention mechanisms, and executes detailed proposals in order of higher relevance. Examples of inputs to the AI model include: (1) simultaneous time-series data of blood test values and supplement candidates; (2) correlation data between dietary records and supplement recommendations; (3) health consultation content and supplement candidate information. The AI model outputs (a) proposal order list (e.g., iron supplement prioritized with relevance score 0.92 to dietary content), (b) proposal content with relevance scores, and (c) summary proposals for low-relevance supplements. The proposal unit presents proposal content to the user that emphasizes highly relevant supplements based on these outputs. Unlike conventional uniform proposal order or manual relevance determination, the present system achieves technical effects such as improved proposal efficiency, prevention of overlooking important supplements, and multifaceted evaluation of complex health conditions through AI-based automatic relevance estimation and dynamic proposal order control. Application fields include not only nutrition management for conception and pregnant women, but also prevention of lifestyle-related diseases, sports nutrition guidance, chronic disease management, personal health monitoring, and various healthcare domains.

The visualization unit is capable of estimating the user's emotions and adjusting the visualization method based on the estimated emotions. The visualization unit uses generative AI to estimate the user's emotions and adjusts the visualization method according to the estimated emotions. For example, when the user is feeling stressed, the visualization unit provides simple and easy-to-understand graphs. The visualization unit uses generative AI to estimate the user's emotions and adjusts the visualization method based on the estimated emotions. For instance, when the user is relaxed, the visualization unit provides detailed charts. The visualization unit uses generative AI to estimate the user's emotions and adjusts the visualization method based on the estimated emotions. For example, when the user is in a hurry, the visualization unit provides visualizations focusing on key points. By adjusting the visualization method according to the user's emotions, the visualization unit can provide more appropriate visualizations. Emotion estimation is realized, for example, by using an emotion engine or emotion estimation function implemented with generative AI. Generative AI may include text generation AI (such as LLMs) or multimodal generative AI, but is not limited to these examples. Specifically, the visualization unit receives multimodal inputs from the collection unit, such as the user's natural language input (e.g., text data like “I've been feeling down lately” or “I'm feeling good today”), voice data (e.g., time-series vectors of voice tone and speaking rate), and facial expression images (e.g., two-dimensional arrays of facial feature points). The visualization unit performs normalization and feature extraction on these data in the preprocessing unit (e.g., emotion embedding vectorization using BERT, conversion to voice spectrograms, extraction of facial expression features), and the analysis unit outputs emotion labels (e.g., “stress,” “relaxation,” “tension”), emotion intensity scores (e.g., 0.88), and reasons for estimation (e.g., “Stress state is estimated from speech content and facial expression”). Examples of inputs to the AI model include: (1) natural language queries such as “Please tell me your recent dietary habits”; (2) time-series data of calorie intake and iron intake over the past week; (3) emotional state from voice input. The AI model outputs selection labels for visualization methods (e.g., “simple graph,” “detailed chart,” “key point emphasis”), detail level scores for visualization content (e.g., 0.92), and recommended reasons (e.g., “Information volume suppressed due to stress state”) based on these inputs. The visualization unit automatically generates and immediately reflects in the user interface simple formats such as line graphs or bar graphs for stress states, detailed formats such as radar charts or heat maps for relaxed states, and summary graphs emphasizing only key points for hurried states. Furthermore, the visualization unit annotates the graphs with AI-generated recommended reasons and cautions, enabling users to intuitively understand information presentation according to their emotional state. Unlike conventional uniform graph displays or manual visualization adjustments, the present system achieves technical effects such as improved user comprehension, stress reduction, and optimization of information transmission efficiency through AI-based multimodal emotion estimation and dynamic visualization control. Application fields include not only nutrition management for conception and pregnant women, but also stress management, mental health care, personal assistants, telemedicine, educational support, and various other fields.

The visualization unit is capable of selecting an appropriate visualization method at the time of visualization by referring to the user's past health indicators. The visualization unit uses generative AI to select an appropriate visualization method at the time of visualization by referring to the user's past health indicators. For example, the visualization unit selects an appropriate graph format based on the user's past health indicators. The visualization unit uses generative AI to select an appropriate visualization method at the time of visualization by referring to the user's past health indicators. For instance, the visualization unit visually displays fluctuations in the user's health indicators in an easy-to-understand manner. The visualization unit uses generative AI to select an appropriate visualization method at the time of visualization by referring to the user's past health indicators. For example, the visualization unit selects the optimal visualization technique by referring to the user's past health indicators. By referring to the user's past health indicators, the visualization unit can select the optimal visualization method. Specifically, the visualization unit receives past health indicator data from the collection unit (e.g., time-series vectors or tensors of blood test values, weight, BMI, blood pressure, blood glucose, etc.), and performs time-series alignment, outlier removal, normalization, and other processing in the preprocessing unit. The visualization unit inputs these data into an AI model (e.g., time-series analysis neural networks or large language models) to analyze fluctuation patterns of health indicators (e.g., stable type, increasing trend, sudden fluctuation) and feature extraction (e.g., periodicity, timing of abnormal values). Examples of inputs to the AI model include: (1) time-series data of Hb values over the past year; (2) weight and BMI trends over three months; (3) weekly records of blood pressure and blood glucose. The AI model outputs (a) recommended visualization format labels (e.g., “line graph,” “heat map,” “radar chart”), (b) detail level scores for visualization content (e.g., large fluctuation 0.92, recommending detailed graphs), and (c) recommended reasons (e.g., “Detailed visualization recommended due to sudden fluctuation in the past three months”) based on these inputs. The visualization unit automatically selects the optimal graph format for the user's health indicator fluctuations based on these outputs, generating summary graphs for stable types and detailed time-series graphs or abnormal value emphasis graphs for fluctuating types, and displays them in the user interface. Furthermore, the visualization unit annotates the graphs with AI-generated notes and cautions (e.g., “Period when Hb value fell below the standard value”) to enable users to intuitively grasp changes in their health status. Unlike conventional uniform graph displays or manual visualization selection, the present system achieves technical effects such as improved visualization accuracy, early detection of abnormal values, and enhanced personalization for each user through AI-based time-series data analysis and dynamic selection of visualization techniques. Application fields include not only nutrition management for conception and pregnant women, but also prevention of lifestyle-related diseases, sports nutrition guidance, chronic disease management, personal health monitoring, and various healthcare domains.

The visualization unit is capable of customizing the means of visualization at the time of visualization based on the user's current health status. The visualization unit uses generative AI to customize the means of visualization at the time of visualization according to the user's current health status. For example, the visualization unit evaluates the user's current health status and selects an appropriate means of visualization. The visualization unit uses generative AI to customize the means of visualization at the time of visualization according to the user's current health status. For instance, the visualization unit customizes the format of graphs and charts according to the user's health status. The visualization unit uses generative AI to customize the means of visualization at the time of visualization according to the user's current health status. For example, the visualization unit provides information in a visually easy-to-understand format based on the user's current health status. By customizing the means of visualization according to the user's current health status, the visualization unit can provide more appropriate visualizations. Specifically, the visualization unit normalizes, categorizes, and extracts features from the latest health information received from the collection unit (e.g., numerical vectors of blood test values, weight, BMI, blood pressure, blood glucose), dietary records (e.g., time-series tensors of daily calorie and nutrient intake), and lifestyle information (e.g., categorical data of sleep duration, exercise frequency, stress level) in the preprocessing unit, and inputs the data into an AI model (e.g., multimodal neural networks or large language models). Examples of inputs to the AI model include: (1) time-series data of blood test values and dietary records over the past week; (2) categorical data of latest sleep duration and exercise frequency; (3) health consultation content in natural language. The AI model outputs (a) health status evaluation labels (e.g., “good,” “caution,” “needs improvement”), (b) recommended visualization formats (e.g., “detailed graph,” “summary graph,” “abnormal value emphasis”), and (c) recommended reasons (e.g., “Abnormal value emphasis graph recommended due to blood glucose exceeding the standard value”) based on these inputs. The visualization unit automatically generates and immediately reflects in the user interface a summary graph for good health status, and graphs or detailed charts emphasizing abnormal values or risk factors for caution or needs improvement status. Furthermore, the visualization unit annotates the graphs with AI-generated recommended reasons and cautions, enabling users to intuitively understand information presentation according to their health status. Unlike conventional uniform graph displays or manual visualization adjustments, the present system achieves technical effects such as improved user comprehension, early detection of abnormal values, and optimization of health management efficiency through AI-based health status evaluation and dynamic visualization customization. Application fields include not only nutrition management for conception and pregnant women, but also prevention of lifestyle-related diseases, sports nutrition guidance, chronic disease management, personal health monitoring, and various healthcare domains.

The visualization unit is capable of estimating the user's emotions and determining the priority of visualization based on the estimated emotions. The visualization unit uses generative AI to estimate the user's emotions and determines the priority of visualization according to the estimated emotions. For example, when the user is feeling stressed, the visualization unit prioritizes the visualization of important information. The visualization unit uses generative AI to estimate the user's emotions and determines the priority of visualization based on the estimated emotions. For instance, when the user is relaxed, the visualization unit visualizes detailed information. The visualization unit uses generative AI to estimate the user's emotions and determines the priority of visualization based on the estimated emotions. For example, when the user is in a hurry, the visualization unit prioritizes the visualization of key information. By determining the priority of visualization according to the user's emotions, the visualization unit can prioritize the visualization of more important information. Emotion estimation is realized, for example, by using an emotion engine or emotion estimation function implemented with generative AI. Generative AI may include text generation AI (such as LLMs) or multimodal generative AI, but is not limited to these examples. Specifically, the visualization unit receives multimodal inputs from the collection unit, such as the user's natural language input (e.g., “I've been irritated lately,” “I'm feeling good today”), voice data (e.g., time-series vectors of speaking rate and voice tone), and facial expression images (e.g., two-dimensional arrays of facial feature points). The visualization unit performs normalization and feature extraction on these data in the preprocessing unit (e.g., emotion embedding using BERT, conversion to voice spectrograms, extraction of facial expression features), and the analysis unit outputs emotion labels (e.g., “stress,” “relaxation,” “tension”), emotion intensity scores (e.g., 0.88), and reasons for estimation (e.g., “Stress state is estimated from speech content and facial expression”). Examples of inputs to the AI model include: (1) health consultation content and emotional state over the past week; (2) emotional state from voice input; (3) emotion estimation from facial expression images. The AI model outputs visualization priority lists (e.g., Hb value>iron intake>sleep duration), priority scores (e.g., Hb value 0.95), and recommended reasons (e.g., “Important indicators prioritized for visualization due to stress state”) based on these inputs. The visualization unit generates and immediately reflects in the user interface graphs of important information such as health risks or abnormal values during stress, multifaceted visualization of detailed information during relaxation, and summary graphs emphasizing only key points when in a hurry. Furthermore, the visualization unit annotates the graphs with AI-generated recommended reasons and cautions, enabling users to intuitively understand information presentation according to their emotional state. Unlike conventional uniform graph displays or manual prioritization, the present system achieves technical effects such as improved user comprehension, prevention of overlooking important information, and optimization of information transmission efficiency through AI-based multimodal emotion estimation and dynamic visualization priority control. Application fields include not only nutrition management for conception and pregnant women, but also stress management, mental health care, personal assistants, telemedicine, and various other fields.

The visualization unit is capable of selecting the optimal visualization method at the time of visualization by considering the user's geographic location information. The visualization unit uses generative AI to select the optimal visualization method at the time of visualization by considering the user's geographic location information. For example, the visualization unit visualizes region-specific health information based on the user's current location. The visualization unit uses generative AI to select the optimal visualization method at the time of visualization by considering the user's geographic location information. For instance, the visualization unit compares and visualizes regional health indicators based on the user's geographic location information. The visualization unit uses generative AI to select the optimal visualization method at the time of visualization by considering the user's geographic location information. For example, the visualization unit selects the optimal visualization technique by considering the user's geographic location information. By considering the user's geographic location information, the visualization unit can visualize region-specific health information. Specifically, the visualization unit receives GPS coordinates and location information (e.g., latitude/longitude, prefecture, city/town categorical data) obtained from user terminals or wearable devices from the collection unit, and performs geocoding and area classification (e.g., urban, rural, coastal) in the preprocessing unit. The visualization unit inputs these location data and health/nutrition databases (e.g., region-specific food distribution information, supplement store lists, region-specific nutrition risks) into an AI model (e.g., large language models or multimodal neural networks) to analyze region-specific health indicators and nutrition risks. Examples of inputs to the AI model include: (1) user's current location (latitude/longitude) and health indicator data for the past month; (2) region-specific food distribution information and user's dietary records; (3) nearby supplement store lists. The AI model outputs (a) recommended visualization formats (e.g., “regional comparison graph,” “heat map,” “region-specific risk emphasis”), (b) region-specific health indicator lists (e.g., “Iron deficiency is common in this region”), and (c) recommended reasons (e.g., “Tendency for high iodine intake in coastal areas”) based on these inputs. The visualization unit automatically generates and displays in the user interface graphs and charts optimized for regional characteristics (e.g., region-specific health indicator comparison graphs, regional risk heat maps) based on these outputs. Furthermore, the visualization unit annotates the graphs with AI-generated notes and region-specific cautions, enabling users to intuitively grasp health information according to their residence or activity area. Unlike conventional uniform graph displays or manual selection of regional information, the present system achieves technical effects such as optimized information presentation for regional characteristics, improved user experience, and early identification of regional nutrition risks through AI-based location information integration and dynamic selection of visualization techniques. Application fields include not only nutrition management for conception and pregnant women, but also regional medical collaboration, nutrition support during disasters, health services for tourists, regional revitalization support, and various other fields.

The visualization unit is capable of analyzing the user's social media activity at the time of visualization and proposing means of visualization. The visualization unit uses generative AI to analyze the user's social media activity at the time of visualization and propose means of visualization. For example, the visualization unit analyzes the user's social media posts and proposes visualization methods based on interests. The visualization unit uses generative AI to analyze the user's social media activity at the time of visualization and propose means of visualization. For instance, the visualization unit visualizes relevant health information based on the user's social media follow relationships. The visualization unit uses generative AI to analyze the user's social media activity at the time of visualization and propose means of visualization. For example, the visualization unit analyzes the user's social media activity history and proposes appropriate means of visualization. By analyzing the user's social media activity, the visualization unit can propose visualization methods based on interests. Specifically, the visualization unit receives the user's social media post data (e.g., time-series data of text posts, image posts, video links), follow/follower relationships (e.g., graph structure data of user IDs), and reaction history to posts (e.g., categorical data of likes, comments, shares) from the collection unit, and performs normalization, tokenization, and feature extraction for sentiment analysis (e.g., embedding vectorization using BERT or RoBERTa) for text posts, image feature extraction (e.g., label estimation using CNN) for image posts, and calculation of network centrality and clustering indices for graph data in the preprocessing unit. The visualization unit inputs these diverse features into an AI model (e.g., multimodal neural networks or large language models) to estimate the user's interest topics (e.g., “iron,” “vitamin D,” “diet”), emotional tendencies (e.g., “health anxiety,” “motivation improvement”), and influence scores on the social graph (e.g., health information diffusion score 0.85). Examples of inputs to the AI model include: (1) time-series data of health-related post texts over the past 30 days; (2) list of health influencers followed; (3) automatic labels of food photos in image posts. The AI model outputs (a) recommended visualization formats (e.g., “topic-specific graph,” “influencer recommendation emphasis,” “emotional tendency heat map”), (b) interest labels (e.g., “iron supplementation,” “low-carb diet”), and (c) recommended reasons (e.g., “Detailed graph recommended due to high frequency of health-related posts”) based on these inputs. The visualization unit automatically generates and displays in the user interface graphs and charts matching the user's interests (e.g., topic-specific health indicator graphs, influencer recommendation emphasis graphs) based on these outputs. Furthermore, the visualization unit annotates the graphs with AI-generated notes and cautions for related topics, enabling users to intuitively understand information presentation according to their interests. Unlike conventional uniform graph displays or manual estimation of interests, the present system achieves technical effects such as improved personalization for each user, significant improvement in information presentation efficiency, and enhanced accuracy of relevant data acquisition through AI-based high-dimensional multimodal data analysis and dynamic proposal of visualization methods. Application fields include not only nutrition management for conception and pregnant women, but also prevention of lifestyle-related diseases, sports nutrition guidance, personal healthcare, SNS-linked health services, and various healthcare domains.

The system according to the embodiment is not limited to the examples described above, and various modifications are possible, for example, as follows. Specifically, the present system, through modular design of each component (collection unit, analysis unit, proposal unit, visualization unit), has the feature of being able to flexibly expand and modify the types of input data, AI model architectures, data flows, output formats, and so on. For example, the system may be configured to additionally acquire real-time biometric data (e.g., time-series tensors of heart rate, skin temperature, activity level) from new sensor devices (e.g., wearable activity trackers, smartwatches, IoT body composition scales) in the collection unit, or to combine graph neural networks and time-series analysis neural networks (e.g., LSTM, TCN) with conventional Transformer-based large language models in the analysis unit to perform complex health status estimation and anomaly detection. Furthermore, the proposal unit can implement more advanced personalized proposals and risk-based recommendations by linking user attribute information (e.g., age, gender, medical history, genetic information) and external medical databases. The visualization unit can also introduce advanced display methods such as diversification of user interfaces (e.g., smartphone apps, web dashboards, voice assistant integration), 3D graphs, interactive charts, and AR visualization. These modifications not only automate human tasks, but also improve computer technology itself, such as high-dimensional data integration analysis by AI, dynamic control, enhanced real-time responsiveness, maximized personalization, improved anomaly detection accuracy, and optimized user experience. Application fields include not only nutrition management for conception and pregnant women, but also prevention of lifestyle-related diseases, sports nutrition guidance, chronic disease management, telemedicine, personal healthcare, corporate health management support, education, and care/welfare domains, and the ability to flexibly customize required data types, AI models, and output specifications for each field is a major technical advantage of the present system.

The collection unit is capable of collecting the user's purchase history, and the analysis unit can analyze this information to propose supplements based on the user's purchasing trends. For example, the system analyzes the types and frequency of supplements purchased by the user in the past and proposes new supplements based on similar needs. In addition, the collection unit can detect deficiencies in specific nutrients from the user's purchase history and propose supplements to compensate for those deficiencies. Furthermore, the collection unit can propose supplements according to seasons or events based on the user's purchase history. Specifically, the collection unit automatically acquires the user's purchase history data (e.g., time-series table data including purchase date, product category, supplement name, purchase frequency, purchase quantity) from EC site APIs or POS-linked systems. The collection unit performs normalization, category conversion, time-series alignment, outlier removal, and other processing in the preprocessing unit and transmits the data to the analysis unit. The analysis unit uses Transformer-based large language models and purchase behavior analysis neural networks (e.g., time-series LSTM, purchase pattern classification CNN) to perform purchase trend clustering (e.g., “regular iron supplement user,” “seasonal type”), nutrient intake trend estimation (e.g., iron supplement purchase frequency 0.85), and event linkage analysis (e.g., increased folic acid supplement purchases after pregnancy confirmation). Examples of inputs to the AI model include: (1) time-series data of supplement purchase history over the past year; (2) purchase frequency vectors by product category; (3) purchase history at the time of events (e.g., pregnancy, seasonal changes). The AI model outputs (a) recommended supplement list (e.g., “iron supplement,” “vitamin D supplement”), (b) recommended reasons (e.g., “Iron supplement purchases have decreased over the past three months, increasing the risk of iron deficiency”), and (c) season/event-linked recommendations (e.g., “Vitamin C supplement recommended during pollen season”) based on these inputs. The proposal unit automatically generates personalized proposals considering the user's purchasing trends, nutrient deficiency risks, and seasonal/event factors based on these outputs and presents them to the user. Unlike conventional simple reference to purchase history or manual proposals, the present system achieves technical effects such as improved proposal accuracy, enhanced personalization for each user, early detection of health risks, and season/event-linked health support through AI-based high-dimensional purchase data analysis and dynamic proposal generation. Application fields include not only nutrition management for conception and pregnant women, but also prevention of lifestyle-related diseases, sports nutrition management, health maintenance for seniors, personal healthcare, corporate health management support, and various healthcare domains.

The analysis unit is capable of estimating the user's emotions and adjusting the method of presenting analysis results based on the estimated emotions. For example, when the user is feeling stressed, the analysis unit presents the analysis results in a simple and easy-to-understand format. When the user is relaxed, the analysis unit can also provide detailed analysis results. Furthermore, when the user is in a hurry, the analysis unit can present concise analysis results focusing on key points. Specifically, the analysis unit normalizes and extracts features from multimodal data received from the collection unit, such as the user's natural language input (e.g., “I've been feeling down lately,” “I'm feeling good today”), voice data (e.g., time-series vectors of voice tone and speaking rate), and facial expression images (e.g., two-dimensional arrays of facial feature points), in the preprocessing unit, and inputs the data into a multimodal neural network. The AI model outputs emotion labels (e.g., “stress,” “relaxation,” “tension”), emotion intensity scores (e.g., 0.88), and reasons for estimation (e.g., “Stress state is estimated from speech content and facial expression”). Based on these outputs, the analysis unit dynamically switches the method of presenting analysis results (e.g., detailed explanation, summary, bullet points) in the analysis result generation module according to the user's emotional state. Examples of inputs to the AI model include: (1) time-series data of dietary records and health indicators over the past week; (2) health consultation content in natural language; (3) emotional state from voice input. The AI model automatically selects the format for presenting analysis results based on these inputs to optimize the user experience. Unlike conventional uniform presentation of analysis results or manual adjustment of expressions, the present system achieves technical effects such as improved user comprehension, stress reduction, and optimization of information transmission efficiency through AI-based multimodal emotion estimation and dynamic control of presentation methods. Application fields include not only nutrition management for conception and pregnant women, but also stress management, mental health care, personal assistants, telemedicine, and various other fields.

The proposal unit is capable of estimating the user's emotions and adjusting the proposal content based on the estimated emotions. For example, when the user is feeling stressed, the proposal unit recommends supplements with relaxation effects. When the user is fatigued, the proposal unit can also recommend supplements suitable for energy replenishment. Furthermore, when the user has positive emotions, the proposal unit can also recommend supplements that help maintain health. Specifically, the proposal unit normalizes and extracts features from the user's natural language input (e.g., “I've been irritated lately,” “I'm feeling good today”), voice data (e.g., time-series vectors of speaking rate and voice tone), and facial expression images (e.g., two-dimensional arrays of facial feature points) received from the collection unit in the preprocessing unit, and the analysis unit outputs emotion labels (e.g., “stress,” “fatigue,” “positive”), emotion intensity scores (e.g., 0.85), and reasons for estimation (e.g., “Fatigue state is estimated from speech content and voice tone”). Examples of inputs to the AI model include: (1) health consultation content and emotional state over the past week; (2) emotional state from voice input; (3) emotion estimation from facial expression images. The AI model outputs recommended supplement categories (e.g., “relaxation type,” “energy replenishment type,” “health maintenance type”), recommended reasons (e.g., “GABA supplement recommended due to stress state”), and recommendation scores (e.g., 0.92) based on these inputs. The proposal unit dynamically switches the proposal content according to the user's emotional state based on these outputs, prioritizing supplements with relaxation effects during stress, energy replenishment supplements during fatigue, and health maintenance supplements during positive emotions. Unlike conventional uniform proposals or manual emotion determination, the present system achieves technical effects such as improved personalization for each user, early detection of health risks, and improved proposal accuracy through AI-based multimodal emotion estimation and dynamic proposal control. Application fields include not only nutrition management for conception and pregnant women, but also stress management, mental health care, personal assistants, telemedicine, and various other fields.

The visualization unit is capable of monitoring the user's health indicators in real time and displaying alerts when abnormalities are detected. For example, when the user's blood pressure rises sharply, the visualization unit displays an alert to prompt caution. When the user's blood glucose shows abnormal values, the visualization unit can also immediately display an alert. Furthermore, when the user's weight increases or decreases rapidly, the visualization unit can also display an alert. Specifically, the visualization unit receives health indicator data (e.g., time-series vectors or tensors of blood pressure, blood glucose, weight, BMI, pulse, etc.) from the collection unit, performs time-series alignment, outlier removal, normalization, and other processing in the preprocessing unit, and inputs the data into an AI model (e.g., time-series anomaly detection neural networks or large language models). Examples of inputs to the AI model include: (1) time-series data of blood pressure, blood glucose, and weight over the past month; (2) daily health indicator transition tensors; (3) real-time biometric sensor data. The AI model outputs (a) anomaly detection labels (e.g., “sharp rise in blood pressure,” “abnormal blood glucose,” “rapid weight gain”), (b) anomaly scores (e.g., blood pressure 0.95), and (c) recommended actions (e.g., “recommend visiting a medical institution,” “recommend dietary improvement”) based on these inputs. The visualization unit immediately displays alerts on the user interface using an alert display module when abnormalities are detected, and annotates the graphs with details of the abnormality, recommended responses, and cautions. Unlike conventional simple numerical displays or manual anomaly monitoring, the present system achieves technical effects such as early detection of abnormal values, rapid notification of health risks, and optimization of user experience through AI-based high-dimensional time-series data analysis and automatic anomaly detection and alert display. Application fields include not only nutrition management for conception and pregnant women, but also prevention of lifestyle-related diseases, sports nutrition guidance, chronic disease management, personal health monitoring, and various healthcare domains.

The collection unit is capable of collecting the user's exercise data, and the analysis unit can analyze this data to propose supplements according to the amount of exercise. For example, the system analyzes the types and frequency of exercise performed by the user on a daily basis and proposes supplements to support recovery after exercise. In addition, the system estimates the consumption of specific nutrients from the user's exercise data and proposes supplements suitable for replenishment. Furthermore, the system can propose supplements to improve exercise performance based on the user's exercise data. Specifically, the collection unit automatically acquires the user's exercise data (e.g., time-series tensors or categorical data of steps, calories burned, exercise type, exercise duration, heart rate) from wearable devices or smartphone apps. The collection unit performs normalization, category conversion, outlier removal, and other processing in the preprocessing unit and transmits the data to the analysis unit. The analysis unit uses time-series analysis neural networks (e.g., LSTM, TCN) or multimodal neural networks to perform exercise pattern classification (e.g., “aerobic exercise type,” “strength training type”), nutrient consumption estimation (e.g., protein consumption 0.85), and performance improvement factor analysis (e.g., delayed recovery after exercise). Examples of inputs to the AI model include: (1) time-series data of exercise type and amount over the past week; (2) tensors of heart rate transitions after exercise; (3) categorical data of exercise frequency and calories burned. The AI model outputs (a) recommended supplement list (e.g., “BCAA supplement,” “magnesium supplement”), (b) recommended reasons (e.g., “Increased protein consumption due to increased strength training frequency”), and (c) performance improvement recommendations (e.g., “Recommend protein intake within 30 minutes after exercise”) based on these inputs. The proposal unit automatically generates personalized proposals according to the user's amount of exercise and performance goals based on these outputs and presents them to the user. Unlike conventional simple reference to exercise records or manual proposals, the present system achieves technical effects such as improved proposal accuracy, enhanced personalization for each user, and optimization of exercise performance through AI-based high-dimensional exercise data analysis and dynamic proposal generation. Application fields include not only nutrition management for conception and pregnant women, but also sports nutrition management, prevention of lifestyle-related diseases, health maintenance for seniors, personal healthcare, and various healthcare domains.

The analysis unit is capable of estimating the user's emotions and determining the priority of analysis based on the estimated emotions. For example, when the user is feeling stressed, the analysis unit prioritizes the analysis of information related to stress reduction. When the user is relaxed, the analysis unit can also prioritize the analysis of information related to health maintenance. Furthermore, when the user is in a hurry, the analysis unit can also prioritize the analysis of important information. Specifically, the analysis unit normalizes and extracts features from the user's natural language input (e.g., “I've been irritated lately,” “I'm feeling good today”), voice data (e.g., time-series vectors of speaking rate and voice tone), and facial expression images (e.g., two-dimensional arrays of facial feature points) received from the collection unit in the preprocessing unit, and inputs the data into a multimodal neural network. The AI model outputs emotion labels (e.g., “stress,” “relaxation,” “tension”), emotion intensity scores (e.g., 0.88), and reasons for estimation (e.g., “Stress state is estimated from speech content and facial expression”). Based on these outputs, the analysis unit controls the analysis priority determination module to prioritize the analysis of stress reduction information (e.g., relaxation methods, sleep improvement measures) during stress, health maintenance information (e.g., nutritional balance, exercise habits) during relaxation, and highly important information (e.g., recent health risk factors) when in a hurry. Examples of inputs to the AI model include: (1) health consultation content and emotional state over the past week; (2) emotional state from voice input; (3) emotion estimation from facial expression images. The AI model outputs analysis priority lists (e.g., stress reduction>health maintenance>important information), priority scores (e.g., stress reduction 0.95), and recommended reasons (e.g., “Stress reduction information prioritized for analysis due to stress state”) based on these inputs. Unlike conventional uniform analysis order or manual prioritization, the present system achieves technical effects such as improved analysis efficiency, rapid acquisition of important information, and optimization of user experience through AI-based multimodal emotion estimation and dynamic analysis priority control. Application fields include not only nutrition management for conception and pregnant women, but also stress management, mental health care, personal assistants, telemedicine, and various other fields.

The proposal unit is capable of collecting the user's dietary preferences, and the analysis unit can analyze this information to propose supplements based on the user's preferences. For example, when the user prefers certain foods, the system proposes supplements to compensate for nutrients contained in those foods. When the user avoids certain foods, the system can also propose supplements to compensate for nutrients contained in those foods. Furthermore, the system can propose supplements considering dietary balance based on the user's preferences. Specifically, the collection unit automatically acquires the user's dietary preference data (e.g., lists of preferred foods, disliked foods, allergy information, preference tags from dietary record apps, categorical data, and natural language input). The collection unit performs category conversion, feature extraction, allergy exclusion processing, and other processing in the preprocessing unit and transmits the data to the analysis unit. The analysis unit uses Transformer-based large language models and preference pattern classification neural networks to perform preference clustering (e.g., “Japanese food preference type,” “dairy avoidance type”), nutrient intake trend estimation (e.g., calcium deficiency risk 0.85 due to dairy avoidance), and balance evaluation (e.g., PFC balance score). Examples of inputs to the AI model include: (1) lists of preferred/disliked foods and dietary records; (2) allergy information and dietary preference tags; (3) dietary preference input in natural language. The AI model outputs (a) recommended supplement list (e.g., “calcium supplement,” “vitamin B12 supplement”), (b) recommended reasons (e.g., “Calcium supplementation recommended due to dairy avoidance”), and (c) balance optimization proposals (e.g., “Recommend increasing protein intake”) based on these inputs. The proposal unit automatically generates and presents to the user supplement proposals optimized for the user's preferences and nutritional balance based on these outputs. Unlike conventional uniform proposals or manual preference determination, the present system achieves technical effects such as improved proposal accuracy, enhanced personalization for each user, and early detection of health risks through AI-based high-dimensional preference data analysis and dynamic proposal generation. Application fields include not only nutrition management for conception and pregnant women, but also prevention of lifestyle-related diseases, sports nutrition management, health maintenance for seniors, personal healthcare, allergy-friendly dietary support, and various healthcare domains.

The visualization unit is capable of estimating the user's emotions and adjusting the visualization method based on the estimated emotions. For example, when the user is feeling stressed, a simple and easy-to-understand graph is provided. When the user is relaxed, a detailed chart may be provided. Furthermore, when the user is in a hurry, visualization focusing only on key points may be performed. Specifically, the visualization unit normalizes and extracts features from user natural language input received from the collection unit (e.g., “I've been feeling down lately”, “I'm feeling good today”), voice data (e.g., time-series vectors of voice tone and speaking rate), and facial expression images (e.g., two-dimensional arrays of facial feature points) in a preprocessing unit (e.g., emotion embedding using BERT, conversion to voice spectrogram, extraction of facial expression features), and the analysis unit outputs emotion labels (e.g., “stress”, “relaxation”, “tension”), emotion intensity scores (e.g., 0.88), and reasons for estimation (e.g., “Stress state is estimated from speech content and facial expression”). Examples of inputs to the AI model include (1) natural language queries such as “Please tell me your recent dietary habits”, (2) time-series data of calorie intake and iron intake over the past week, and (3) emotional state from voice input. The AI model outputs, based on these inputs, visualization method selection labels (e.g., “simple graph”, “detailed chart”, “key point emphasis”), detail level scores for visualization content (e.g., 0.92), and recommended reasons (e.g., “Information volume suppressed due to stress state”). Based on these outputs, the visualization unit automatically generates and immediately reflects on the user interface a simple format such as line graphs or bar graphs in the case of stress, a detailed format such as radar charts or heat maps in the case of relaxation, and a summary graph emphasizing only key points in the case of urgency. Furthermore, the visualization unit annotates the graph with AI-generated recommended reasons and cautions, enabling the user to intuitively understand the information presentation according to their emotional state. Unlike conventional uniform graph displays or manual visualization adjustments, the present system achieves technical effects such as improved user comprehension, stress reduction, and optimization of information transmission efficiency through AI-based multimodal emotion estimation and dynamic visualization control. Application fields include not only nutrition management for fertility and pregnant women, but also stress management, mental healthcare, personal assistants, telemedicine, educational support, and various other fields.

The collection unit collects the user's sleep data, and the analysis unit analyzes the data to propose supplements according to the quality of sleep. For example, the user's sleep duration and sleep depth are analyzed, and supplements to improve sleep quality are proposed. In addition, specific nutrient deficiencies may be detected from the user's sleep data, and supplements suitable for replenishing those nutrients may be proposed. Furthermore, based on the user's sleep data, supplements that help improve sleep disorders may also be proposed. Specifically, the collection unit automatically acquires the user's sleep data (e.g., sleep duration, ratio of deep sleep to light sleep, sleep onset and wake-up times, time-series tensors of heart rate and body movement during sleep) from wearable devices or smartphone applications. The collection unit processes these data in the preprocessing unit by normalization, outlier removal, feature extraction, and the like, and transmits them to the analysis unit. The analysis unit uses time-series analysis neural networks (e.g., LSTM, TCN) and multimodal neural networks to perform sleep pattern classification (e.g., “short sleep type”, “interrupted sleep type”), sleep quality score estimation (e.g., 0.85), nutrient deficiency risk estimation (e.g., magnesium deficiency risk 0.78), and sleep disorder risk estimation (e.g., tendency for sleep apnea). Examples of inputs to the AI model include (1) time-series data of sleep duration and depth over the past week, (2) time-series tensors of heart rate during sleep, and (3) integrated data of sleep records and health indicators. The AI model outputs, based on these inputs, (a) recommended supplement lists (e.g., “melatonin supplement”, “magnesium supplement”), (b) reasons for recommendation (e.g., “Sleep improvement supplement recommended due to decreased proportion of deep sleep”), and (c) recommendations for sleep disorder improvement (e.g., “Medical consultation recommended due to tendency for sleep apnea”). The proposal unit automatically generates personalized proposals according to the user's sleep quality and disorder risk based on these outputs and presents them to the user. Unlike conventional simple reference to sleep records or manual proposals, the present system achieves technical effects such as improved proposal accuracy, increased personalization for each user, and early detection of sleep disorder risks through AI-based high-dimensional sleep data analysis and dynamic proposal generation. Application fields include not only fertility and pregnant women, but also prevention of lifestyle-related diseases, sports nutrition management, health maintenance for seniors, personal healthcare, and support for sleep disorder countermeasures in various healthcare domains.

The proposal unit is capable of estimating the user's emotions and determining the priority of proposals based on the estimated emotions. For example, when the user is feeling stressed, supplements related to stress reduction are preferentially proposed. When the user is relaxed, supplements related to health maintenance may be preferentially proposed. Furthermore, when the user is in a hurry, important supplements may be preferentially proposed. Specifically, the proposal unit normalizes and extracts features from user natural language input received from the collection unit (e.g., “I've been irritated lately”, “I'm feeling good today”), voice data (e.g., time-series vectors of speaking rate and voice tone), and facial expression images (e.g., two-dimensional arrays of facial feature points) in a preprocessing unit (e.g., emotion embedding using BERT, conversion to voice spectrogram, extraction of facial expression features), and the analysis unit outputs emotion labels (e.g., “stress”, “relaxation”, “tension”), emotion intensity scores (e.g., 0.85), and reasons for estimation (e.g., “Stress state is estimated from speech content and voice tone”). Examples of inputs to the AI model include (1) health consultation content and emotional state over the past week, (2) emotional state from voice input, and (3) emotion estimation from facial expression images. The AI model outputs, based on these inputs, proposal priority lists (e.g., stress reduction supplements>health maintenance supplements >important supplements), priority scores (e.g., stress reduction 0.95), and recommended reasons (e.g., “Stress reduction supplement is preferentially proposed due to stress state”). Based on these outputs, the proposal unit dynamically switches the priority of proposal content according to the user's emotional state, preferentially proposing stress reduction supplements during stress, health maintenance supplements during relaxation, and important supplements when the user is in a hurry. Unlike conventional uniform proposal order or manual prioritization, the present system achieves technical effects such as improved proposal efficiency, rapid acquisition of important supplements, and optimization of user experience through AI-based multimodal emotion estimation and dynamic proposal prioritization control. Application fields include not only nutrition management for fertility and pregnant women, but also stress management, mental healthcare, personal assistants, telemedicine, and various other fields.

Below, the processing flow of Example of the Embodiment will be briefly described. Specifically, in the present system, each module—the collection unit, analysis unit, proposal unit, and visualization unit—works in cooperation to integratively process diverse health-related data of the user in high dimensions. The collection unit acquires multimodal inputs such as user health information (e.g., numerical vectors of blood test values, body weight, BMI, blood pressure, blood glucose, etc.), dietary information (e.g., time-series tensors of daily calorie intake and nutrient intake), lifestyle habit information (e.g., categorical data of sleep duration, exercise frequency, stress level, etc.), natural language input (e.g., “I've been getting tired easily lately”, “Please tell me your dietary habits”), voice data (e.g., time-series vectors of speaking rate and voice tone), and facial expression images (e.g., two-dimensional arrays of facial feature points). The collection unit processes these data in the preprocessing unit by normalization, category conversion, feature extraction, noise removal, outlier removal, time-series alignment, missing value imputation, and the like, and transmits them to the analysis unit. The analysis unit uses Transformer-based large language models, multimodal neural networks, time-series analysis neural networks (e.g., LSTM, TCN), graph neural networks, and the like to perform multifaceted analyses such as health status estimation, nutrient deficiency risk determination, emotion estimation, lifestyle habit clustering, anomaly detection, importance estimation, relevance analysis, and category determination. Examples of inputs to the AI model include (1) time-series data of blood test values and dietary records over the past week, (2) categorical data of sleep duration and exercise frequency, (3) health consultation content in natural language, (4) emotional state from voice input, and (5) emotion estimation from facial expression images. The AI model outputs, based on these inputs, (a) health status scores (e.g., Hb value 0.92, BMI 23.5), (b) nutrient deficiency risks (e.g., iron deficiency 0.85), (c) emotion labels (e.g., “stress”, “relaxation”), (d) analysis priority lists, (e) recommended supplement lists, (f) recommended reasons, and (g) recommended visualization formats. The proposal unit automatically generates personalized supplement proposals based on the analysis results obtained from the analysis unit, comprehensively considering the user's health status, emotional state, lifestyle habits, dietary preferences, and the like, and explains the recommended reasons, intake amounts, cautions, and so on in natural language. The visualization unit automatically generates graphs and charts (e.g., line graphs, radar charts, heat maps, etc.) showing the effects of the proposed supplements, transitions of health indicators, anomalies, risk factors, and the like, and dynamically optimizes the display format and annotation content according to the user's emotional state and health status. Unlike conventional simple numerical displays or manual graph creation, the present system achieves technical effects such as improved user comprehension, optimization of health management efficiency, early detection of anomalies, and improved information transmission efficiency through AI-based high-dimensional data integration analysis, dynamic control, personalized proposals, and automatic visualization. Application fields include not only nutrition management for fertility and pregnant women, but also prevention of lifestyle-related diseases, sports nutrition guidance, chronic disease management, personal health monitoring, telemedicine, corporate health management support, and various other healthcare domains.

Step 1: The collection unit collects user information. The user information includes, for example, health information, dietary information, and lifestyle habit information. When the user asks questions or consults with the AI chatbot in natural language, the collection unit collects that information. Step 2: The analysis unit analyzes the information collected by the collection unit using generative AI. The analysis is performed, for example, using statistical analysis or machine learning algorithms. The generative AI analyzes the collected information to propose supplements according to the user's needs or circumstances. Step 3: The proposal unit proposes supplements based on the analysis results obtained by the analysis unit using generative AI. The proposals include, for example, proposals based on the user's health status or personalized proposals. The generative AI can also detect iron deficiency in the user and propose supplements containing iron. Step 4: The visualization unit visualizes the effects of the supplements proposed by the proposal unit using generative AI. Visualization is performed, for example, using graphs or charts. The generative AI displays the user's health indicators or nutritional intake status in graphs or charts, making it easier for the user to understand their health status and supporting appropriate nutritional management. Specifically, in Step 1, the collection unit acquires multimodal inputs such as user health information (e.g., numerical vectors of blood test values, body weight, BMI, blood pressure, blood glucose, etc.), dietary information (e.g., time-series tensors of daily calorie intake and nutrient intake), lifestyle habit information (e.g., categorical data of sleep duration, exercise frequency, stress level, etc.), natural language input (e.g., “I've been getting tired easily lately”, “Please tell me your dietary habits”), voice data (e.g., time-series vectors of speaking rate and voice tone), and facial expression images (e.g., two-dimensional arrays of facial feature points). The collection unit processes these data in the preprocessing unit by normalization, category conversion, feature extraction, noise removal, outlier removal, time-series alignment, missing value imputation, and the like, and transmits them to the analysis unit. In Step 2, the analysis unit uses Transformer-based large language models, multimodal neural networks, time-series analysis neural networks (e.g., LSTM, TCN), graph neural networks, and the like to perform multifaceted analyses such as health status estimation, nutrient deficiency risk determination, emotion estimation, lifestyle habit clustering, anomaly detection, importance estimation, relevance analysis, and category determination. Examples of inputs to the AI model include (1) time-series data of blood test values and dietary records over the past week, (2) categorical data of sleep duration and exercise frequency, (3) health consultation content in natural language, (4) emotional state from voice input, and (5) emotion estimation from facial expression images. The AI model outputs, based on these inputs, (a) health status scores (e.g., Hb value 0.92, BMI 23.5), (b) nutrient deficiency risks (e.g., iron deficiency 0.85), (c) emotion labels (e.g., “stress”, “relaxation”), (d) analysis priority lists, (e) recommended supplement lists, (f) recommended reasons, and (g) recommended visualization formats. In Step 3, the proposal unit automatically generates personalized supplement proposals based on the analysis results obtained from the analysis unit, comprehensively considering the user's health status, emotional state, lifestyle habits, dietary preferences, and the like, and explains the recommended reasons, intake amounts, cautions, and so on in natural language. In Step 4, the visualization unit automatically generates graphs and charts (e.g., line graphs, radar charts, heat maps, etc.) showing the effects of the proposed supplements, transitions of health indicators, anomalies, risk factors, and the like, and dynamically optimizes the display format and annotation content according to the user's emotional state and health status. Unlike conventional simple numerical displays or manual graph creation, the present system achieves technical effects such as improved user comprehension, optimization of health management efficiency, early detection of anomalies, and improved information transmission efficiency through AI-based high-dimensional data integration analysis, dynamic control, personalized proposals, and automatic visualization. Application fields include not only nutrition management for fertility and pregnant women, but also prevention of lifestyle-related diseases, sports nutrition guidance, chronic disease management, personal health monitoring, telemedicine, corporate health management support, and various other healthcare domains.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned collection unit, analysis unit, proposal unit, and visualization unit is implemented by at least one of, for example, a smart device 14 and a data processing apparatus 12. For example, the collection unit is implemented by a computer 36 of the smart device 14 and collects user health information and dietary information. The analysis unit is implemented, for example, by a specific processing unit 290 of the data processing apparatus 12 and analyzes the collected information. The proposal unit is implemented, for example, by the specific processing unit 290 of the data processing apparatus 12 and proposes supplements based on the analysis result. The visualization unit is implemented, for example, by a control unit 46A of the smart device 14 and displays the effects of the proposed supplements in a graph or chart. The correspondence between each unit and the apparatus or control unit is not limited to the examples described above and various modifications are possible.

### Second Embodiment

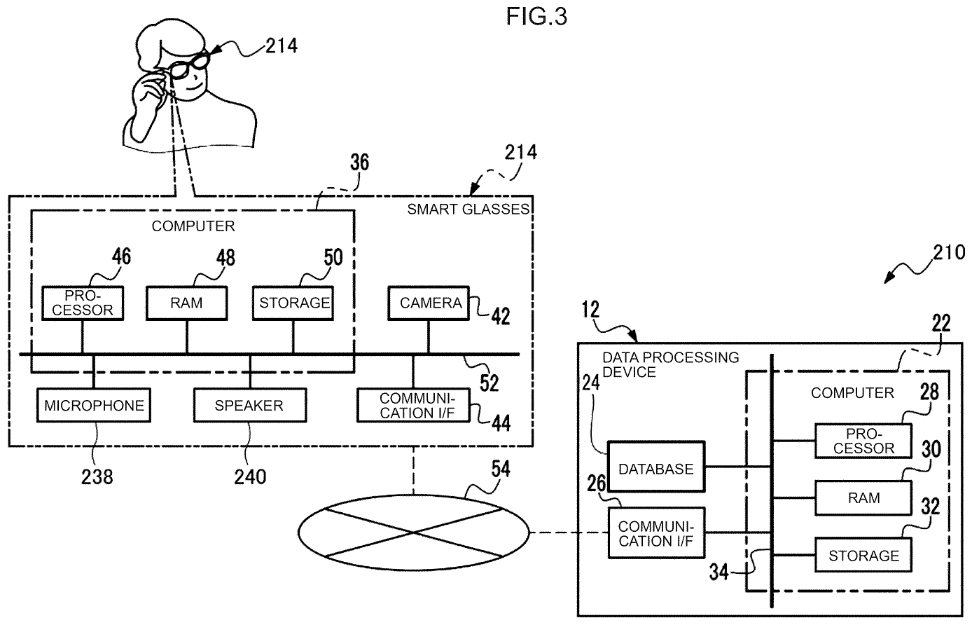

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

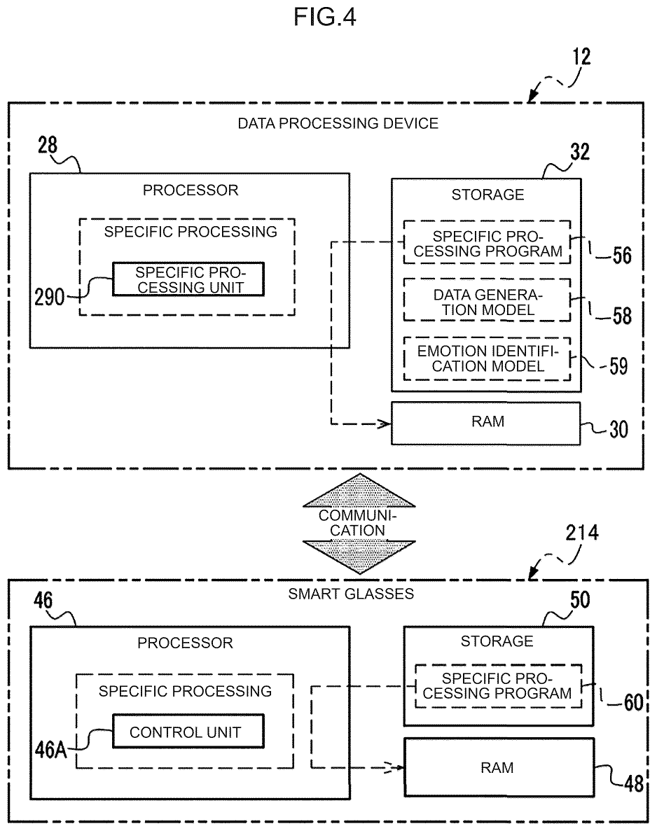

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned collection unit, analysis unit, proposal unit, and visualization unit is implemented by at least one of, for example, smart glasses 214 and a data processing apparatus 12. For example, the collection unit is implemented by a computer 36 of the smart glasses 214 and collects user health information and dietary information. The analysis unit is implemented, for example, by a specific processing unit 290 of the data processing apparatus 12 and analyzes the collected information. The proposal unit is implemented, for example, by the specific processing unit 290 of the data processing apparatus 12 and proposes supplements based on the analysis result. The visualization unit is implemented, for example, by a control unit 46A of the smart glasses 214 and displays the effects of the proposed supplements in a graph or chart. The correspondence between each unit and the apparatus or control unit is not limited to the examples described above and various modifications are possible.

### Third Embodiment

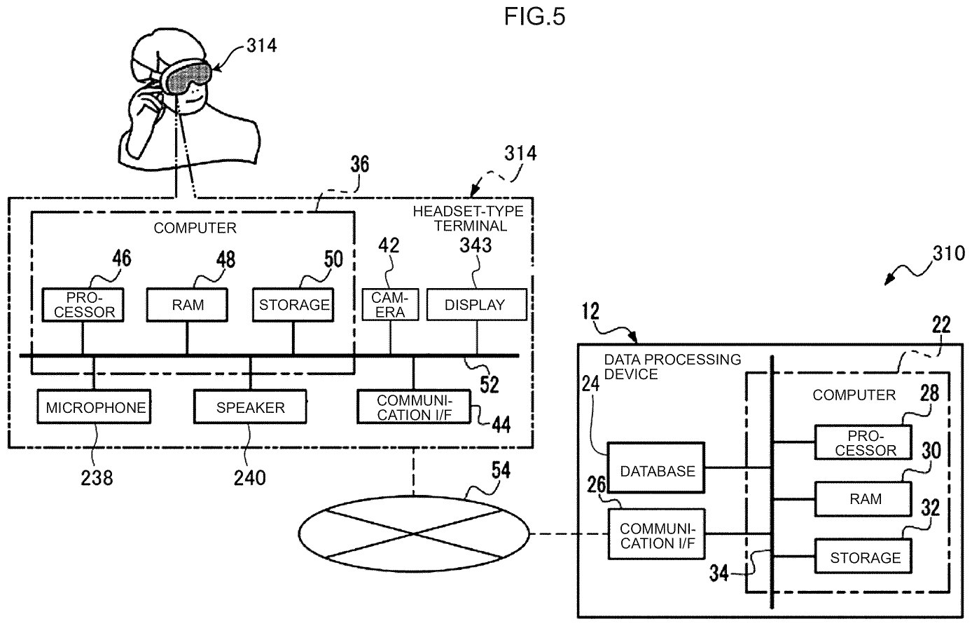

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

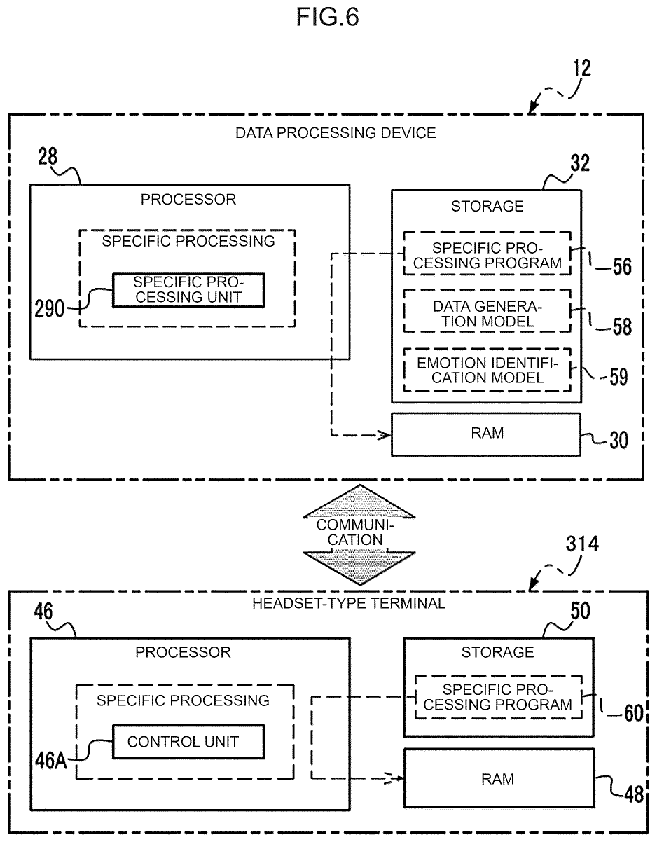

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned collection unit, analysis unit, proposal unit, and visualization unit is implemented by at least one of, for example, a headset-type terminal 314 and a data processing apparatus 12. For example, the collection unit is implemented by a computer 36 of the headset-type terminal 314 and collects user health information and dietary information. The analysis unit is implemented, for example, by a specific processing unit 290 of the data processing apparatus 12 and analyzes the collected information. The proposal unit is implemented, for example, by the specific processing unit 290 of the data processing apparatus 12 and proposes supplements based on the analysis result. The visualization unit is implemented, for example, by a control unit 46A of the headset-type terminal 314 and displays the effects of the proposed supplements in a graph or chart. The correspondence between each unit and the apparatus or control unit is not limited to the examples described above and various modifications are possible.

### Fourth Embodiment

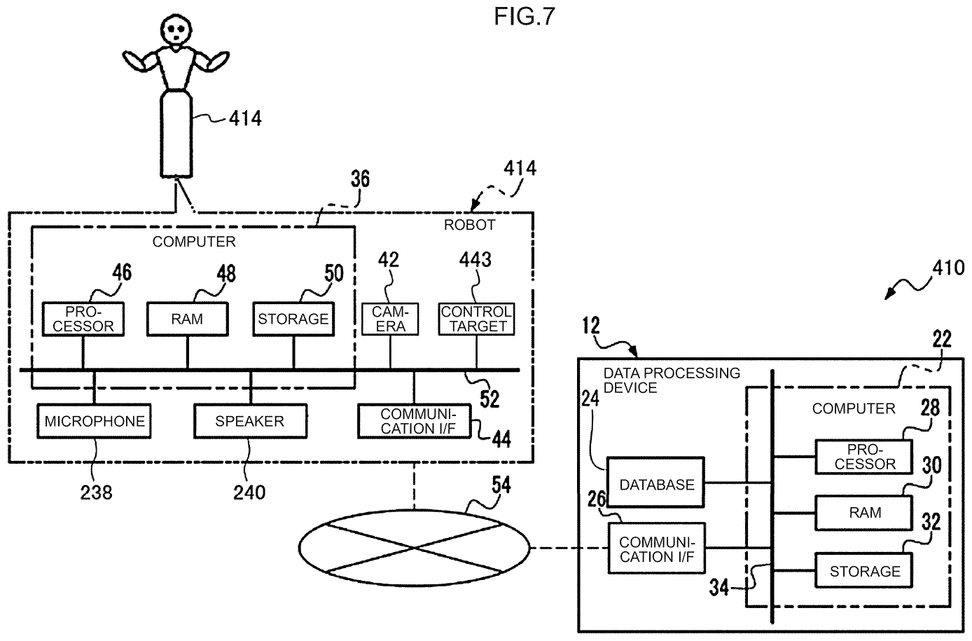

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

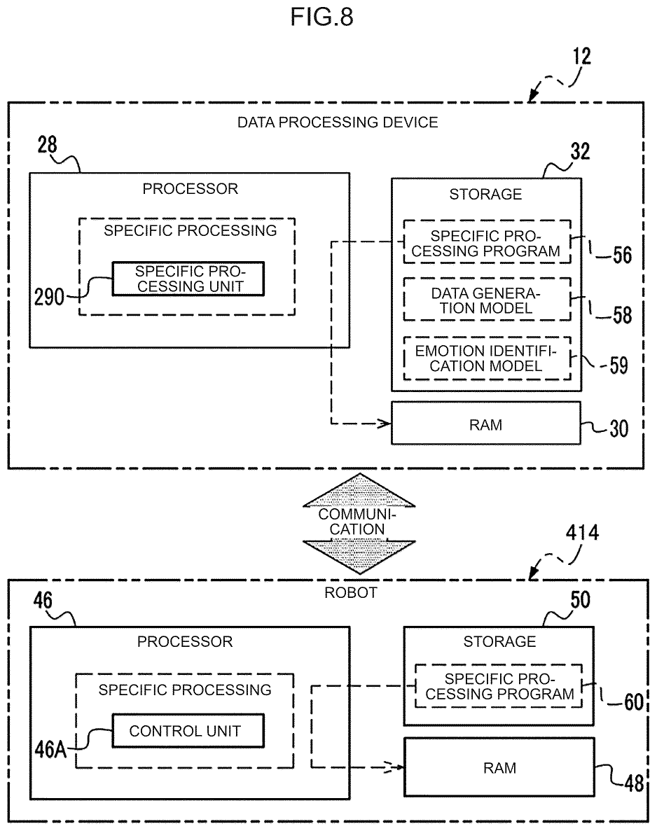

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned collection unit, analysis unit, proposal unit, and visualization unit is implemented by at least one of, for example, a robot 414 and a data processing apparatus 12. For example, the collection unit is implemented by a computer 36 of the robot 414 and collects user health information and dietary information. The analysis unit is implemented, for example, by a specific processing unit 290 of the data processing apparatus 12 and analyzes the collected information. The proposal unit is implemented, for example, by the specific processing unit 290 of the data processing apparatus 12 and proposes supplements based on the analysis result. The visualization unit is implemented, for example, by a control unit 46A of the robot 414 and displays the effects of the proposed supplements in a graph or chart. The correspondence between each unit and the apparatus or control unit is not limited to the examples described above and various modifications are possible.

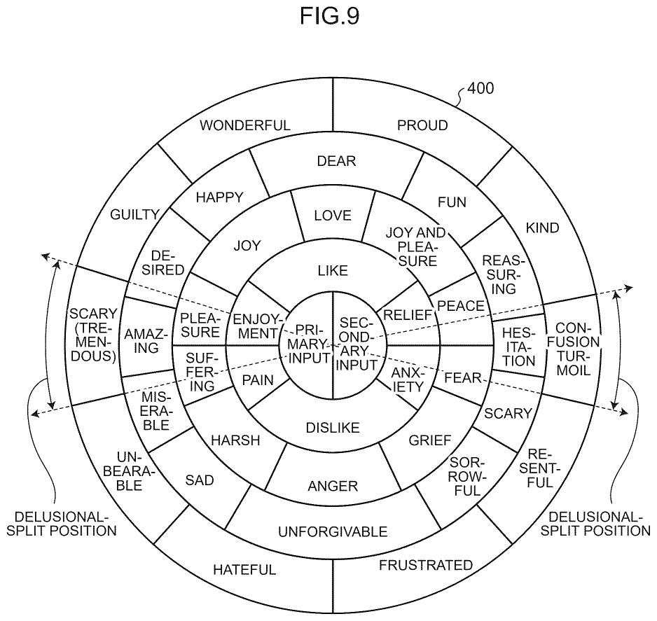

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

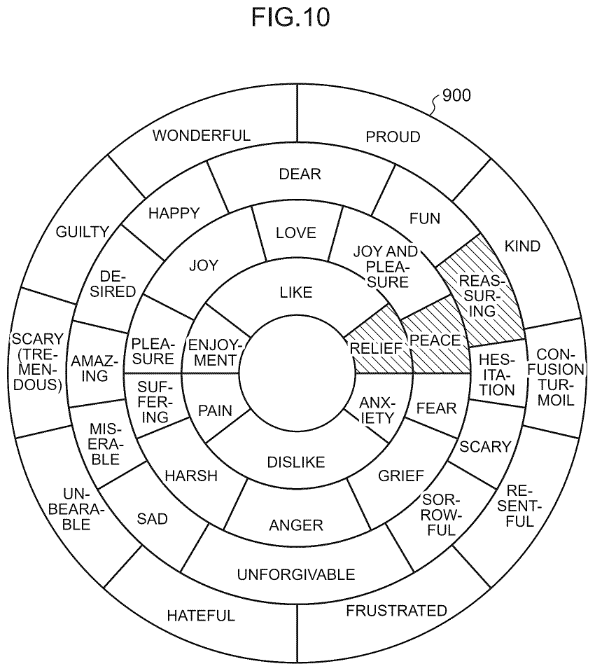

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1)A system comprising: a collection unit configured to collect user information; an analysis unit configured to analyze the information collected by the collection unit; a proposal unit configured to propose supplements based on an analysis result obtained by the analysis unit; and a visualization unit configured to visualize the effects of the supplements proposed by the proposal unit.
(Supplementary Note 2)The system according to Supplementary Note 1, wherein the collection unit is configured to collect information regarding a user's diet or lifestyle habits.
(Supplementary Note 3)The system according to Supplementary Note 1, wherein the analysis unit is configured to analyze the collected information and propose supplements according to the user's needs or circumstances.
(Supplementary Note 4)The system according to Supplementary Note 1, wherein the visualization unit is configured to display a user's health indicators or nutritional intake status in a graph or chart.
(Supplementary Note 5)The system according to Supplementary Note 1, wherein the proposal unit is configured to detect iron deficiency in the user and propose supplements containing iron.
(Supplementary Note 6)The system according to Supplementary Note 1, wherein the visualization unit is configured to visualize the effects of the proposed supplements and provide them to the user.
(Supplementary Note 7)The system according to Supplementary Note 1, wherein the collection unit is configured to estimate the user's emotions and adjust the timing of information collection based on the estimated emotions.
(Supplementary Note 8)The system according to Supplementary Note 1, wherein the collection unit is configured to analyze the user's past dietary history and select an appropriate information collection method.
(Supplementary Note 9)The system according to Supplementary Note 1, wherein the collection unit is configured to perform filtering based on the user's current health status or lifestyle habits at the time of information collection.
(Supplementary Note 10)The system according to Supplementary Note 1, wherein the collection unit is configured to estimate the user's emotions and determine the priority of information to be collected based on the estimated emotions.
(Supplementary Note 11)The system according to Supplementary Note 1, wherein the collection unit is configured to preferentially collect highly relevant information based on the user's geographic location information at the time of information collection.
(Supplementary Note 12)The system according to Supplementary Note 1, wherein the collection unit is configured to analyze the user's social media activity at the time of information collection and collect relevant information.
(Supplementary Note 13)The system according to Supplementary Note 1, wherein the analysis unit is configured to estimate the user's emotions and adjust the expression method of analysis based on the estimated emotions.
(Supplementary Note 14)The system according to Supplementary Note 1, wherein the analysis unit is configured to adjust the level of detail of analysis based on the importance of the collected information during analysis.
(Supplementary Note 15)The system according to Supplementary Note 1, wherein the analysis unit is configured to apply different analysis algorithms according to the category of information during analysis.
(Supplementary Note 16)The system according to Supplementary Note 1, wherein the analysis unit is configured to estimate the user's emotions and adjust the length of analysis based on the estimated emotions.
(Supplementary Note 17)The system according to Supplementary Note 1, wherein the analysis unit is configured to determine the priority of analysis based on the timing of information collection during analysis.
(Supplementary Note 18)The system according to Supplementary Note 1, wherein the analysis unit is configured to adjust the order of analysis based on the relevance of the information during analysis.
(Supplementary Note 19)The system according to Supplementary Note 1, wherein the proposal unit is configured to estimate the user's emotions and adjust the expression method of proposals based on the estimated emotions.
(Supplementary Note 20)The system according to Supplementary Note 1, wherein the proposal unit is configured to adjust the level of detail of proposals based on the importance of the supplements at the time of proposal.
(Supplementary Note 21)The system according to Supplementary Note 1, wherein the proposal unit is configured to apply different proposal algorithms according to the category of supplements at the time of proposal.
(Supplementary Note 22)The system according to Supplementary Note 1, wherein the proposal unit is configured to estimate the user's emotions and adjust the length of proposals based on the estimated emotions.
(Supplementary Note 23)The system according to Supplementary Note 1, wherein the proposal unit is configured to determine the priority of proposals based on the submission timing of the supplements at the time of proposal.
(Supplementary Note 24)The system according to Supplementary Note 1, wherein the proposal unit is configured to adjust the order of proposals based on the relevance of the supplements at the time of proposal.
(Supplementary Note 25)The system according to Supplementary Note 1, wherein the visualization unit is configured to estimate the user's emotions and adjust the visualization method based on the estimated emotions.
(Supplementary Note 26)The system according to Supplementary Note 1, wherein the visualization unit is configured to select an appropriate visualization method by referring to the user's past health indicators at the time of visualization.
(Supplementary Note 27)The system according to Supplementary Note 1, wherein the visualization unit is configured to customize the means of visualization based on the user's current health status at the time of visualization.
(Supplementary Note 28)The system according to Supplementary Note 1, wherein the visualization unit is configured to estimate the user's emotions and determine the priority of visualization based on the estimated emotions.
(Supplementary Note 29)The system according to Supplementary Note 1, wherein the visualization unit is configured to select an optimal visualization method by considering the user's geographic location information at the time of visualization.
(Supplementary Note 30)The system according to Supplementary Note 1, wherein the visualization unit is configured to analyze the user's social media activity at the time of visualization and propose means of visualization.

What is claimed is:

1. A system comprising:
a communication interface configured to communicate with a client terminal via a packet-switched network;
a memory storing a data generation model comprising a Transformer-based architecture obtained by deep learning on a neural network, and an emotion identification model; and
circuitry configured to:
receive, from the client terminal via the communication interface, structured data comprising at least one of time-series numerical data, categorical data, or natural language text data;
estimate an emotion of a user by applying the emotion identification model to sensor data received from the client terminal;
analyze the structured data by inputting the structured data together with the estimated emotion into the data generation model to generate inference data comprising at least one of a recommendation label, a probability score, or natural language explanation text;
generate rendering data for a visualization of the inference data, the rendering data comprising parameters for at least one of a time-series graph, a radar chart, or a heat map; and
transmit the inference data and the rendering data to the client terminal via the communication interface and the packet-switched network.

2. The system according to claim 1, wherein the structured data comprises health information of a user, the health information comprising at least one of blood test result values, body weight, body mass index, blood pressure, or blood glucose level as numerical vectors.

3. The system according to claim 1, wherein the structured data further comprises dietary record data comprising daily caloric intake and nutrient intake amounts as time-series tensors.

4. The system according to claim 1, wherein the structured data further comprises lifestyle habit data comprising at least one of sleep duration, exercise frequency, or stress level as categorical data.

5. The system according to claim 1, wherein the circuitry is further configured to preprocess the structured data by performing at least one of normalization, missing value imputation, or category conversion before inputting the structured data into the data generation model.

6. The system according to claim 1, wherein the data generation model comprises a multimodal neural network configured to integratively analyze the natural language text data and the time-series numerical data.

7. The system according to claim 1, wherein the inference data comprises a supplement recommendation label and a recommendation score, and wherein the circuitry is further configured to perform threshold determination based on the recommendation score to determine whether to include the supplement recommendation label in the transmitted inference data.

8. The system according to claim 1, wherein the circuitry is further configured to adjust a timing of receiving the structured data from the client terminal based on the estimated emotion, such that when the estimated emotion indicates stress, the circuitry delays the receiving, and when the estimated emotion indicates relaxation, the circuitry receives the structured data immediately.

9. The system according to claim 1, wherein the circuitry is further configured to determine a priority of the structured data to be received based on the estimated emotion, such that when the estimated emotion indicates stress, the circuitry prioritizes receiving structured data having a high importance attribute.

10. The system according to claim 1, wherein the circuitry is further configured to adjust a level of detail of the inference data based on the estimated emotion, such that when the estimated emotion indicates stress, the circuitry generates concise inference data, and when the estimated emotion indicates relaxation, the circuitry generates detailed inference data.

11. The system according to claim 1, wherein the circuitry is further configured to adjust an expression style of the inference data based on the estimated emotion, such that when the estimated emotion indicates stress, the inference data is generated in a simplified expression style, and when the estimated emotion indicates relaxation, the inference data is generated in a detailed expression style.

12. The system according to claim 1, wherein the circuitry is further configured to calculate an importance score for each item of the structured data and to adjust a level of detail of analysis based on the importance score, such that detailed analysis is performed for structured data having a high importance score and simplified analysis is performed for structured data having a low importance score.

13. The system according to claim 1, wherein the circuitry is further configured to apply different analysis algorithms according to a category of the structured data.

14. The system according to claim 1, wherein the circuitry is further configured to receive geographic location information of the user from the client terminal and to preferentially receive structured data associated with a geographic region corresponding to the geographic location information.

15. The system according to claim 1, wherein the circuitry is further configured to receive social media activity data of the user from the client terminal, analyze the social media activity data using a natural language processing model to extract interest topics, and adjust a priority of the structured data to be received based on the extracted interest topics.

16. The system according to claim 1, wherein the rendering data further comprises anomaly detection indicators, and wherein the circuitry is further configured to automatically detect data fluctuations and outliers in the structured data and to include alert display parameters in the rendering data.

17. The system according to claim 1, wherein the circuitry is further configured to adjust a visualization format of the rendering data based on the estimated emotion, such that when the estimated emotion indicates stress, the rendering data comprises parameters for a simplified graph format, and when the estimated emotion indicates relaxation, the rendering data comprises parameters for a detailed chart format.

18. A system comprising:
a communication interface configured to communicate, via a packet-switched network conforming to at least one of a 5G, Wi-Fi, or Bluetooth communication standard, with a client terminal comprising a touch panel, a microphone, a speaker, a camera having a CMOS image sensor, and a display;
a processor;
a random-access memory;
a memory storing a data generation model comprising a Transformer-based architecture obtained by deep learning on a neural network, and an emotion identification model; and
circuitry configured to:
receive, from the client terminal via the communication interface, structured data comprising at least one of time-series numerical data representing health indicators, categorical data representing lifestyle habits, or natural language text data representing user queries;
preprocess the structured data by performing at least one of normalization, missing value imputation, or category conversion;
estimate an emotion of a user by applying the emotion identification model to at least one of voice data captured by the microphone or image data captured by the camera;
analyze the preprocessed structured data by inputting the preprocessed structured data together with the estimated emotion into the data generation model to generate inference data comprising at least one of a recommendation label, a probability score, or natural language explanation text;
adjust at least one of a level of detail, an expression style, or a length of the inference data based on the estimated emotion;
generate rendering data for a visualization of the inference data, the rendering data comprising parameters for at least one of a time-series line graph, a radar chart, or a heat map; and
transmit the inference data and the rendering data to the client terminal via the communication interface, the inference data and the rendering data causing the client terminal to present the inference data and the visualization to the user via at least one of the display or the speaker.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a system comprising a communication interface, a memory storing a data generation model comprising a Transformer-based architecture obtained by deep learning on a neural network and an emotion identification model, the method comprising:
receiving, from a client terminal via the communication interface and a packet-switched network, structured data comprising at least one of time-series numerical data, categorical data, or natural language text data;
estimating an emotion of a user by applying the emotion identification model to sensor data received from the client terminal;
analyzing the structured data by inputting the structured data together with the estimated emotion into the data generation model to generate inference data comprising at least one of a recommendation label, a probability score, or natural language explanation text;
generating rendering data for a visualization of the inference data, the rendering data comprising parameters for at least one of a time-series graph, a radar chart, or a heat map; and
transmitting the inference data and the rendering data to the client terminal via the communication interface and the packet-switched network.
